(19) United States
(12) Patent Application Publication
(10) Pub. No.: US 2008/0263012 A1
(43) Pub. Date: Oct. 23, 2008

(54) Post-Recording Data Analysis and Retrieval

(75) Inventor: Bernard Jones, Kent (GB)

Correspondence Address: BROOKS KUSHMAN P.C., 1000 TOWN CENTER, TWENTY-SECOND FLOOR, SOUTHFIELD, MI, 48075, US

(73) Assignee: ASTRAGROUP AS, Oslo (NO)

(21) Appl. No.: 12/065,377

(22) PCT Filed: Sep. 1, 2006
(86) PCT No.: PCT/GB06/03243

§ 371 Date: Feb. 29, 2008

Related U.S. Application Data
(60) Provisional application No. 60/712,810, filed on Sep. 1, 2005.

(51) Int. Cl. G06F 17/30

(52) U.S. Cl. 707/3; 375/259; 340/10.1

(57) ABSTRACT

When making digital data recordings using some form of computer or calculator, data is input in a variety of ways and stored on some form of electronic medium. During this process calculations and transformations are performed on the data to optimize it for storage. This invention involves designing the calculations in such a way that they include what is needed for each of many different processes, such as data compression, activity detection and object recognition. As the incoming data is subjected to these calculations and stored, information about each of the processes is extracted at the same time. Calculations for the different processes can be executed either serially on a single processor, or in parallel on multiple distributed processors. We refer to the extraction process as “synoptic decomposition”, and to the extracted information as “synoptic data”. The term “synoptic data” does not normally include the main body of original data. The synoptic data is created without any prior bias to specific interrogations that may be made, so it is unnecessary to input search criteria prior to making the recording. Nor does it depend upon the nature of the algorithms/calculations used to make the synoptic decomposition. The resulting data, comprising the (processed) original data together with the (processed) synoptic data, is then stored in a relational database. Alternatively, synoptic data of a simple form can be stored as part of the main data. After the recording is made, the synoptic data can be analyzed without the need to examine the main body of data. This analysis can be done very quickly because the bulk of the necessary calculations have already been done at the time of the original recording. Analyzing the synoptic data provides markers that can be used to access the relevant data from the main data recording if required. The nett effect of doing an analysis in this way is that a large amount of recorded digital data, that might take days or weeks to analyze by conventional means, can be analyzed in seconds or minutes. This invention also relates to a process for generating continuous parameterised families of wavelets. Many of the wavelets can be expressed exactly within 8-bit or 16-bit representations. This invention also relates to processes for using adaptive wavelets to extract information that is robust to variations in ambient conditions, and for performing data compression using locally adaptive quantisation and thresholding schemes, and for performing post recording analysis.

### CROSS REFERENCE TO RELATED APPLICATION

This application claims the benefit of U.S. Provisional Patent Application No. 60/712,810 filed Sep. 1, 2005 the entirety of which is hereby incorporated by reference into this application.

### BACKGROUND OF THE INVENTION

### Field of Invention

Post Recording Analysis

This invention relates to a process that enables very rapid analysis of digital data to be carried out after the data has been recorded.

Parameterisation of Wavelets

This invention relates to a process for generating continuous parameterised families of wavelets. Many of the wavelets can be expressed exactly within 8-bit or 16-bit representations.

Information Extraction, Data Compression and Post Recording Analysis using Wavelets

This invention relates to processes for using adaptive wavelets to extract information that is robust to variations in ambient conditions, and for performing data compression using locally adaptive quantisation and thresholding schemes, and for performing post recording analysis

A vast quantity of digital data is currently being recorded for applications in surveillance, meteorology, geology, medicine, and many other areas. Searching this data to extract relevant information is a tedious and time-consuming process.

Unless specific markers have been set up prior to making the recording, interrogation of the data involves going through the entire data recording to search for the desired information.

Although the process of interrogation can be automated, the need to analyze all the original data limits the speed at which the interrogation can be made. For example digital video recordings can take as long to playback as they do to record, so analyzing them is an extremely lengthy process.

When a crisis situation arises and information is required immediately, the sheer size and number of recordings can make rapid extraction of information impossible.

Where specific markers have been set up a priori, the subsequent interrogation of the recorded data can be done quickly but is limited to the information defined by these markers. The decision about what to look for has to be made before the recording is started and may involve a complicated setup process that has to be done individually for each recording.

A key feature of this invention is that the exact requirements of the interrogation do not have to be specified until after the recording has been made. A standard simple data recording can be made without regard to any future need for data analysis.

Then, if later analysis is needed, the process enables interrogation to be made extremely quickly so that a large quantity of data can be analyzed in a short period of time.

Not only does this provide a huge saving in terms of manpower and cost, but it also becomes possible to analyze a vast quantity of digital information, on a scale that, in practical terms, was previously impossible.

The process applies to any type of streamed digital data, including but not limited to images, audio and seismic data.

The analysis may be of many types including but not limited to changes in the dynamic behaviour of the data and changes in the spatial structure and distribution of the data.

The analysis may be general (for example any non-repetitive movement or any man-sized object) or it may be detailed (for example motion through a specific doorway or similarity to a specific face).

Examples of the type of data that are commonly being analyzed are:
Digital video recordings (to detect particular types of activity)
Digital vide recordings (to recognize certain types of objects, such as faces or number plates)
Seismic recordings (to detect the presence of minerals, etc)
Seismic recordings (to detect the presence of bones, archaeological remains, etc)
Audio recordings (to detect key words, special sounds, voice-patterns, etc)
Medical data recordings (to detect particular features in cardiograms, etc)
Statistical data (to monitor traffic flows, customer purchasing trends, etc)
Environmental data (to analyze meteorological patterns, ocean currents, temperatures, etc)

When analysing video sequences, wavelets are often used for doing image decomposition. The use of wavelets for this purpose has a number of advantages and they have been used in many applications.

Several classes of wavelets have been defined which are particularly well suited to some applications. Examples are the Daubechie and Coiflet wavelets. This invention provides a way of expressing these and all other even-point wavelets in a parameterised way, using a continuous variable. This provides a simple way of computing wavelets that can be automatically selected for optimal scale, and hence adapted to the data content.

Most wavelets, including the Daubechie and Coiflet wavelets, involve the computation of irrational numbers and must be calculated using floating point arithmetic. This invention provides a way of calculating wavelets which are arbitrarily close to any chosen wavelet using integer arithmetic. Integer computations are accurate and reversible with no round off errors, and can be performed on microprocessors using less power and generating less heat than would be required for floating point arithmetic. This has advantages in many situations.

Refinements in methods for filtering noise and discriminating between background motion and intrusive motion are useful for optimising the information content of synoptic data. The present invention provides methods for making a number of such refinements, including the use of a plurality of templates for determining the background, the use of “kernel substitution” also in the determination of the background, and a method of “block scoring” for estimating the significance of pixel differences.

In the compression of video images using wavelets, the use of locally adaptive wavelets provides a mechanism for protecting important details in the images from the consequences of strong compression. By identifying areas in the images which are likely to be of special interest, using a variety of methods for filtering noise and determining the background, masks can be constructed to exclude these areas from the application of strong compression algorithms. In this way areas of special interest retain higher levels of detail than the rest of the image, allowing strong compression methods to be used without compromising the quality of the images.

Wavelet decomposition provides a natural computational environment for many of the processes involved in the generation of synoptic data. The masks created for identifying special areas collectively form a set of data which can be used as synoptic data.

The invention draws on and synthesizes results from many specializations within the field of image processing. In particular, the invention exploits a plurality of pyramidal decompositions of image data based on a number of novel wavelet analysis techniques. The use of a plurality of data representations allows for a plurality of different data views which when combined give robust and reliable indications as to what is happening at the data level. This information is encoded as a set of attribute masks that combine to create synoptic data that can be stored alongside the image data so as to enable high-speed interrogation and correlation of vast quantities of data.

### DESCRIPTION OF RELATED ART

The present invention relates to methods and apparatus from a number of fields among which are: video data mining, video motion detection and classification, image segmentation, wavelet image compression. One of ordinary skill in the art will be well versed in the prior art relating to these fields. One of the principle issues addressed in this invention is the requirement to do this kind of image processing in real time, a requirement that will ever impose greater constraints on algorithms as, for example, television and video recording move to HDTV and beyond.

Variations in scene lighting are a major source of difficulty in segmenting real time video streams. Inter-frame comparisons under such circumstances are difficult and model dependent, particularly when the lighting changes are rapid and episodic. Here we introduce a simple and effective model-independent way if handling this in real time. The method we adopt also allows moving elements in what would otherwise be the image background (swaying trees) to be handled with very low rates of false positive detections.

Image segmentation. The by-now classical paper of Toyoma, K.; Krumm, J.; Brumitt, B.; and Meyers, B. 1999. Wallflower: Principles and practice of background maintainence, In International Conference on Computer Vision, 255-261. and Microsoft Corporation's related web pages (http://research.microsoft.com/˜jckrumm/WallFlower/TestImages.htm) are resources for the “Wallflower system” which is the subject of a vast literature. Segmentation methods based on partial differential equations (as exemplified by Caselles et al. 1997, IEEE Trans Patt. Anal. Machine Intel., 19, 394) are interesting but not yet realistic for real time applications. Among other procedures we find Kalman Filtering, Mixture of Gaussian Models and Hidden Markov models.

Filtering noise from images. This is a subject with a long and venerable history. There is a plethora of methods for identifying the noise component ranging from the facile uniform thresholding to the resource-hungry maximum entropy style methods. The wavelet world has been dominated by the ground-breaking work of Donoho and collaborators (eg: the pioneering D. L. Donoho and I. M. Johnstone, “Ideal spatial adaptation via wavelet shrinkage,” Biometrika, vol. 81, pp. 425-455, 199) and all that followed. There is also a wealth of approaches for feature-preserving noise removal based on nonlinear filters exemplified by early work such as G. Ramponi, “Detail-preserving filter for noisy images”, Electronics Letters, 1995, 31, 865. Filters based on weighted median filters and other order statistics arguably go back to J. W. Tukey's “Nonlinear methods for smoothing data”, Conf. Rec. Eascom (174) p673.”

Classification and Search. Some of the spirit of the current work can be traced back to projects from over a decade ago: VISION (Video Indexing for Searching Over Networks) project, DVLS (Digital Video Library System) and QBIC (Query by Image and Video Content). See for example: M. Flickner, H. Sawhney, W. Niblack, J. Ashley, Q. Huang, B. Dom, M. Gorkani, J. Hafner, D. Lee, D. Petkovic, D. Steele, P. Yanker, Query by Image and Video Content: The QBIC System, Computer, v.28 n.9, p. 23-32, September 1995 and “The VISION Digital Video Library Project” S. Gauch, J. M. Gauch, and K. M. Pua, The Encyclopedia of Library and Information Science. Vol. 68, Supplement 31, 2000, pp. 366-381, 2000. Since those early days there has been much development in this area of automating searches on video data.

Multi-resolution representations and Wavelets in imaging. The use of hierarchical (multi-resolution) wavelet transforms for image handling has a vast literature covering a range of topics including de-noising, feature finding, and data compression. The arguments have often addressed the question as to which wavelet works best and why, with special purpose wavelets being produced for each application.

Other Image processing tasks. Even within the narrow confines of the security and surveillance industry we see imaging applications covering aspects of image acquisition such as camera shake and aspects of image sequence processing such as region matching, movement detection and target tracking. Much of this technology has been built into commercial products. Eliminating random camera movement and tracking systemic movement has been addressed by many researchers. Here we shall cite some work from the astronomy community adaptive optics (AO) programme. Among a number of tested methods, the Quad Correlation method is very simple and effective in a real time situation. Herriot et al. (2000) Proc SPIE, 115, 4007 is the original source. See Thomas et al. (2006) Mon. Not. R Astr. Soc. 371, 323 for a recent review, also in the astronomical image stabilization context.

### SUMMARY OF THE INVENTION

When making digital data recordings using some form of computer or calculator, data is input in a variety of ways and stored on some form of electronic medium. During this process calculations and transformations are performed on the data to optimize it for storage.

This invention involves designing the calculations in such a way that they include what is needed for each of many different processes, such as data compression, activity detection and object recognition.

As the incoming data is subjected to these calculations and stored, information about each of the processes is extracted at the same time.

Calculations for the different processes can be executed either serially on a single processor, or in parallel on multiple distributed processors.

We refer to the extraction process as “synoptic decomposition”, and to the extracted information as “synoptic data”. The term “synoptic data” does not normally include the main body of original data.

The synoptic data is created without any prior bias to specific interrogations that may be made, so it is unnecessary to input search criteria prior to making the recording. Nor does it depend upon the nature of the algorithms/calculations used to make the synoptic decomposition.

The resulting data, comprising the (processed) original data together with the (processed) synoptic data, is then stored in a relational database. Alternatively, synoptic data of a simple form can be stored as part of the main data.

After the recording is made, the synoptic data can be analyzed without the need to examine the main body of data.

This analysis can be done very quickly because the bulk of the necessary calculations have already been done at the time of the original recording.

Analyzing the synoptic data provides markers that can be used to access the relevant data from the main data recording if required.

The nett effect of doing an analysis in this way is that a large amount of recorded digital data, that might take days or weeks to analyze by conventional means, can be analyzed in seconds or minutes.

There is no restriction on the style of user interface needed to perform the analysis.

In one embodiment the present invention relies on real time image processing through which the acquired images are analysed and segmented in such a way as to reliably identify all moving targets in the scene without prejudice as to size, colour, shape, location, pattern of movement, or any other such attribute that one may have in a streamed dataset. The identification of said shall be, insofar as is possible within the available resources, independent of either systemic or random camera movement, and independent of variations in scene illumination.

### BRIEF DESCRIPTION OF DRAWINGS

FIG. 1 is a block diagram of the process in a general form.

FIG. 2 wavelet transformation hierarchy. Different transformations occur between different levels.

FIG. 3 process of generating wavelet family of 4-point wavelets.

FIG. 4 process of generating wavelet families is generalized to 6-point and higher order even point wavelets.

FIG. 5 describes the separate stages of the realization of present invention.

FIG. 6 describes the steps that are taken from the point of acquisition of the data to the point where the data has been refined sufficiently for detailed analysis and production of synoptic data. The steps involve removing artifacts arising out of camera motion and image noise and then resolving the images into static and stationary backgrounds and a dynamic foreground component.

FIG. 7 describes the process of temporally and spatially grouping the pixels of the dynamic foregrounds into a series of object masks that will become the synoptic data.

FIG. 8 describes the data storage process in which the wavelet representation of the image data and the synoptic data are compressed.

FIG. 9 describes the process of data query and retrieval.

FIG. 10 shows the processes taking place after event selection

FIG. 11 shows the processes that go on in the first loop through the analysis of the newly acquired picture.

FIG. 12 Pyramidal transform: each level of the pyramid contains a smaller, lower resolution, version of the original data

FIG. 13 shows how the hierarchy is generated first through the application of a wavelet W₁ and then with a wavelet W₂. The lower panel shows the way in which the data is stored.

FIG. 14 The process of wavelet kernel substitution.

FIG. 15 A set of digital masks extracted from a sequence of images. These masks will later become part of the synoptic data.

FIG. 16 A number of 3×3 patterns, with the scores assigned to the central pixel (upper panels), together with illustration of the total deviant pixel scores in some particular 3×3 blocks (lower panels).

FIG. 17 summarizes the elements of the data compression process.

FIG. 18 shows how there is a one-to-one correspondence between Synoptic image data and wavelet-compressed data.

FIG. 19 shows the steps in the data retrieval and Analysis cycle.

FIG. 20 depicts how data is acquired, processed, stored and retrieved.

### DETAILED DESCRIPTION

### Section 1

### Post Recording Analysis

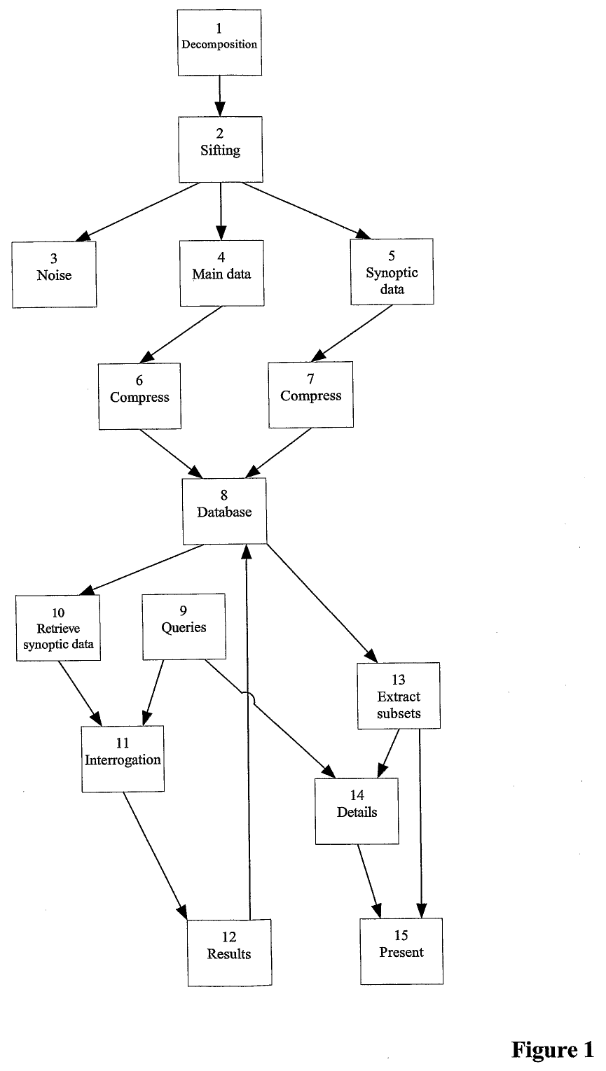

FIG. 1 is a block diagram of the process in a general form. Blocks 1 to 8 comprise the “recorder” and blocks 9 to 15 comprise the “analyser”. Each of the individual blocks represents a smaller process or set of processes that may be novel or known. Sequential digitised data is input to the recorder and undergoes one or more pyramidal decompositions (Block 1). An example of such decomposition is a wavelet transform, but any pyramidal decomposition will do. The decomposed data is “sifted” through one or more “sieves” (Block 2) which separate different types of information content. An example is a noise filter, or a movement detector. The sieves may be applied once or many times in an iterative way. The results of the sifting processes are separated into 3 categories that depend on the purpose of the application:
(a) “unwanted” data (Block 3), which is typically noise, but this category may be null if a lossless treatment or lossless data compression is required;
(b) “main” data (Block 4) which contains all information except (a);
(c) “synoptic” data (Block 5) which consists of the results of a selected number of sifting processes, depending on the purpose of the application.

The key property of synoptic data is that it is sifted data in which the sifting processes have extracted information of a general nature and have not simply identified particular features or events at particular locations in the data.

In optional steps, the separated main data is then compressed (Block 6) and the separated synoptic data may also be compressed (Block 7). If the sifting processes were applied to data at the apex of the pyramidal decomposition, the size of the synoptic data would generally be significantly less than the size of the main data.

The main data and the synoptic data are then stored in a database (Block 8) and sequentially indexed. The index links the main data to the corresponding synoptic data. This completes the recording stage of the process.

The analysis stage begins with setting up an interrogation process (Block 9) that may take the form of specific queries about the data, for example, about the occurrence of particular events, the presence of particular objects having particular properties, or the presence of textural trends in the data sequence. The user interface for this process may take any form, but the queries must be compatible with the format and scope of the synoptic data.

The relevant sequential subsets of the data are determined by the queries, for example, the queries may limit the interrogation to a given time interval, and the corresponding synoptic data is retrieved from the database, and if necessary decompressed (Block 10). The retrieved synoptic data is then interrogated (Block 11). The interrogation process comprises the completion of the sifting processes that were performed in Block 2, carrying them to a conclusive stage that identifies particular features or events at particular locations—spatially or temporally—within the data. The details needed to extract this specific information are supplied at the interrogation stage (Block 9), that is, after the recording has been made. The result of the interrogation is a set of specific locations within the data where the query conditions are satisfied (Block 12). The results are limited by the amount of information contained in the synoptic data. If more detailed results are needed, subsets of the main data corresponding to the identified locations must be retrieved from the database (Block 13) and if necessary decompressed. More detailed sifting is then applied to these subsets to answer the detailed queries (Block 14).

To view the corresponding data resulting from either Blocks 13 or 14 a suitable graphical user interface or other presentation program can be used. This can take any form. If the decompression of the main data is required for either further sifting or viewing (Blocks 13 or 14), the original pyramidal decomposition must be invertible.

The amount of computation needed to extract information from the synoptic data is less than the amount of computation needed to both extract the information and perform further sifting of subsets of the main data, but both of these processes require less computation than the sifting of the recorded main data without the information supplied by the synoptic data.

A detailed embodiment of the process is given in Section 3.

### Section 2

### Wavelets and Wavelet Decomposition

Wavelets in One Dimension

Wavelets in one dimension. The wavelet transform of a one-dimensional data set is a mathematical operation on a stretch of data whereby the data is split by the transformation into two parts. One part is simply a half-size shrunken version of the original data. If this is simply expanded by a factor of two it clearly will not reconstruct the original data from which it came: information was lost in the shrinking process. What is smart about the wavelet transform is that it generates not only the shrunken version of the data, but also a chunk of data that is required to rebuild the original data on expansion.

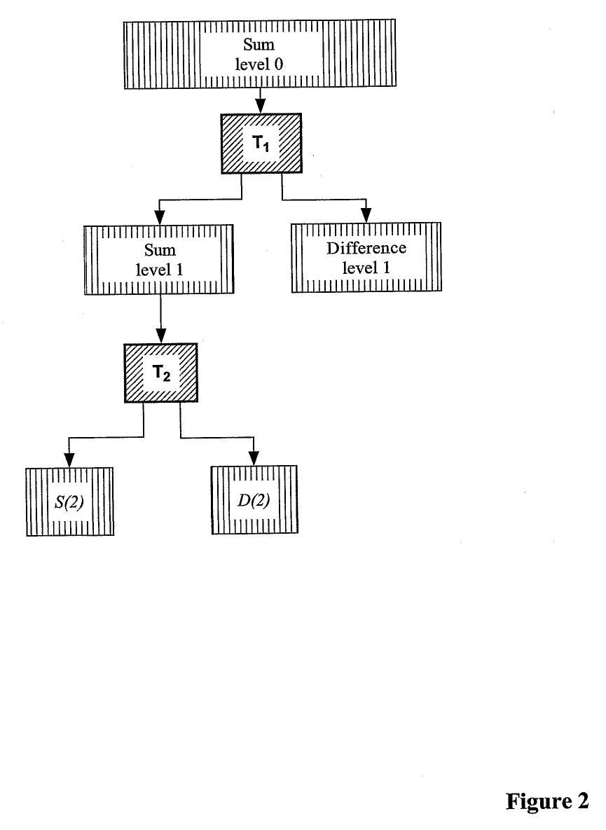

Sums and Differences. Referring to FIG. 2. The transformed data is the same size as the original, but consists of two parts: one part which is the shrunken data and the other which looks like all the features which have to be added back on expansion. We call these the Sum, S, and Difference, D, parts of the wavelet transform.

A trivial example. A totally trivial example is to consider a data set consisting of the two numbers a and b. The sum is S=(a+b)/2, while the difference is D=(a−b)/2. the original data is reconstructed simply by doing a=S+D, b=S−D.

This is the basis of the most elementary of all wavelets: the Haar Wavelet. There is an entire zoo of wavelets doing this while acting on any number of points at the same time. They all have somewhat different properties and do different things to the data. So the outstanding question is always about which of these is the best to use under which circumstances.

Levels. The sum part of the wavelet can itself be wavelet transformed, to produce a piece of 4 times shorter than the original data. This would be regarded as the second level of wavelet transform. The original data is thus Level 0, while the first wavelet transform is then level 1.

It is possible to continue until the shrunken data is simply one point (in practise this requires that the length of the original data be a power of 2).

4-POINT Wavelet Filters.

4-point wavelet filters. N-point wavelet filters were brought to prominence over a decade ago (see I. Daubechies, 1992, Ten Lectures on Wavelets, SIAM, Philadelphia, Pa.) and the history of the wavelet transform goes back long before that. There are numerous reviews on the subject and numerous approaches, all described in numerous books and articles.

Here the point of interest is families of wavelets, and for simplicity we shall fix attention on the 4-point filters. The results generalize to 6 points and higher even number of points.

The 4-point filter. The 4-point wavelet filter has 4 coefficients, which we shall denote by {α₀, α₁, α₂, α₃}. Given the values (h₀, h₁, h₂, h₃) of some function at four equally space points on a line we can calculate two numbers so and do:
s₀=α₀h₀+α₁h₁+α₂h₂+α₃h₃
d₀=α₃h₀−α₂h₁+α₁h₂−α₀h₃ ([0091]).1
If we shift the filter {α₀, α₁, α₂, α₃} along a line of 2N data points, in steps of two points, we can calculate N pairs of numbers (sᵢ,dᵢ). Thus
{h₀,h₁,h₂, . . . , h_{2N}→{s}₀, . . . , s_{N}}{d₀, . . . , d_{N}} ([0091]).2
on rearrangement of the coefficients.
The key requirement is that this transformation be reversible. This imposes the conditions
α₀²+α₁²+α₂²+α₃²=1
α₀α₂+α₁α₃=0 ([0091]).3
We also have
α₀−α₁+α₂−α₃=0
α₀+α₁+α₂+α₃\sqrt{2} ([0091]).4
Further conditions can be imposed in the coefficients so that the transformed data has specific desirable properties such a particular number of vanishing moments.

A Geometric Interpretation

The two relationships ([0091]).3 admit a simple and elegant geometric interpretation that allows us to classify these 4-point wavelets and to find interesting sets of coefficients that have exact integer values.

Refer to FIG. 2. Take a set of rectangular axes {Ox,Oy} with origin O, and draw a line OC at 45°. Put the point C at unit distance from O, and draw a circle of unit diameter with center C. It will be useful to identify the point L where the circle intersects Ox and the point M where the circle intersects Oy. The line OC extends to meet the circle at I, so OI is a diameter and has unit length.

Now consider two points P and Q on the circle such that the angle POQ is a right angle. Then PQ is a diagonal of the circle. Identify ψ as the angle OP makes with the Oy-axis. Then by construction, ψ is the clockwise angle OQ makes with the Ox-axis. Finally, assign coordinates to P and Q:
P=P(α₀,α₃)
Q=Q(α₂,α₁) ([0092]).1
and we have everything we need.
The facts that the circle has unit diameter, and that PQ is a diameter tells us that OP²+OQ²=1. In terms of the assigned coordinates of the points this shows that
α₀²α₁²+α₂²+α₃²=1 ([0092]).2
The orthogonality of the vectors OP and OQ gives
α₁α₃+α₀α₂=0 ([0092]).3
which are precisely equations ([0091]).3. We notice also that since OL=OM=1/√2:
α₀−α₁+α₂−α₃=0
α₀+α₁+α₂+α₃=\sqrt{2} ([0092]).4
which is ([0091]).4.
Note that there is freedom to permute the entries provided the permutations leave the relationships ([0092]).2, ([0092]).3 and ([0092]).4 unaltered. This corresponds to the transformation

$$ψ \to {ψ}^{′} = - ( \frac{π}{4} + ψ ) \qquad ( [ 0092 ] ) .2$$

The 4-point wavelet family. The angle ψ that OP makes with the Oy-axis determines a family of wavelets. It is the complete family of 4-point wavelets since the equations ([0091]).3 are necessary and sufficient conditions on 4-point wavelet coefficients. Without loss of generality we have chosen the range of ψ to be −45°<ψ<+45°.

The more famous wavelets of the family are listed in the table:

| Name | ψ |
|---|---|
| Daubechies 4 | −15° |
| Haar | 0° |
| Coiflet 4 | 15° |

There is a nice, previously unseen, symmetry between the Daubechies 4 and Coiflet 4 wavelets.
The angle ψ gives us a way of saying how close two wavelets of the family are.

An alternative parameterization. We can introduce two numbers, p and q, such that

$$\begin{matrix}tan ψ = \frac{{α}_{3}}{{α}_{0}} = - \frac{{α}_{1}}{{α}_{2}} = - \frac{p}{q} \\ Since & ( [ 0094 ] ) .1 \\ \frac{IP}{OP} = tan ( \frac{π}{4} - ψ ) = \frac{p - q}{p + q} & ( [ 0094 ] ) .2\end{matrix}$$

we have

$${α}_{0} = OP sin ψ = - q \frac{p - q}{p + q} , \\ {α}_{3} = OP cos ψ = p \frac{p - q}{p + q} \qquad ( [ 0094 ] ) .3$$

Whence the wavelet coefficients are

$$\{ {α}_{0} , {α}_{1} , {α}_{2} , {α}_{3} \} = \frac{1}{p + q} \{ \begin{matrix}- q ( p - q ) , q ( p + q ) , \\ p ( p + q ) , p ( p - q )\end{matrix} \} \qquad ( [ 0094 ] ) .4$$

Putting back the correct normalizing factor we get

$$\{ {α}_{0} , {α}_{1} , {α}_{2} , {α}_{3} \} = \frac{1}{\sqrt{2} ( {p}^{2} + {q}^{2} )} \{ \begin{matrix}- q ( p - q ) , q ( p + q ) , \\ p ( p + q ) , p ( p - q )\end{matrix} \} \qquad ( [ 0094 ] ) .5$$

If p and q are integers, we have, apart from the normalization term, integers throughout.

Integer approximations. If we note that \sqrt{3}≈7/4, then the surds appearing in the familiar expressions for the daub4 wavelet are 3+\sqrt{3}≈19/4 and 3−\sqrt{3}≈5/4 whence p=19 and q=5, leading to the un-normalized integer approximation
W_{daub4}≈{−35,60,228,133} ([0095]).1
This corresponds to ψ=−14°.744, compared with the actual value ψ_{daub4}=−15°.
There is another 4-point integer wavelet that is usefully close to this with un-normalized coefficients
W_{A}≈{−3,5,20,12} ([0095]).2
This has ψ=−14°.03.
Note also that the same coefficients can be permuted to give another wavelet
W_{b}≈{−3,12,20,5} ([0095]).3
This has p=5 and q=3, which, as expected, has ψ=−30 °.96. W_{A} and W_{B} have different effective bandwidths.
The simplest such wavelet is
W_{X}≈{−1,2,6,3}
W_{Y}≈{−1,3,6,2} ([0095]).3
W_{X} is known to be the 4-point wavelet with the broadest effective bandwidth.

A dense set of integer approximations. Close to any irrational number there are an infinite number of rational numbers forming a set that approximates ever more closely to the irrational. Hence there are un-normalized wavelets with integer coefficients that lie arbitrarily close to any given wavelet.

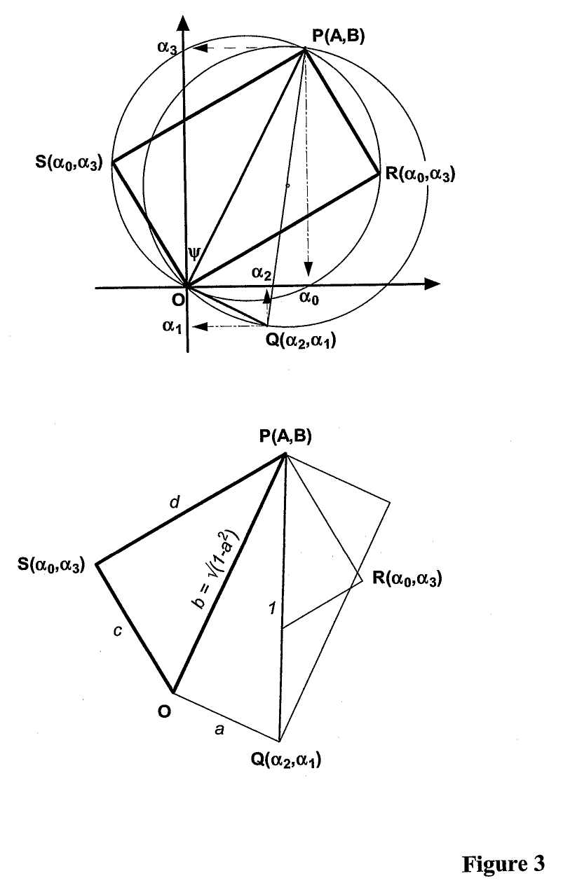

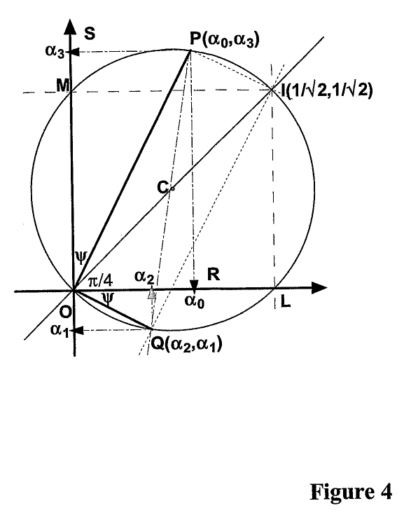

6-point wavelets and higher orders. Referring to FIG. 3, we see how the above process is generalized to 6-point and higher order even point wavelets. The upper panel of FIG. 3 is the an updated version of FIG. 4: The coordinates of P have been re-labelled to P(A,B), a new circle has been added having OP as diameter, and a rectangle ORPS has been drawn inscribed in the new circle. Hence triangles OSP and ORP are right-angled and angle SOR is a right angle; in other words OS and OR are orthogonal. The lower panel of FIG. 3 extracts the rectangle ARPS and the triangle OQP of the upper panel: that is all that is necessary.

It is now easy to verify that the following relationships are satisfied:
α₀²+α₁²+α₂²+α₃²+α₄²+α₅²=1 ([0097]).2
α₀α₂+α₁α₃+α₂α₄+α₃α₅=0
α₀α₃+α₁α₄+α₂α₅=0
α₀α₄+α₁α₅=0 ([0097]).3
α₀−α₁+α₂−α₃+α₄−α₅=0
α₀+α₁+α₂+α₃+α₄+α₅=\sqrt{2} ([0097]).4
and hence with this construction
W{α₀,α₁,α₂,α₃,α₂,α₃} ([0097]).4
Is a 6-point wavelet built on the 4-point {α₀, α₁, α₂, α₃}. Indeed the cycle of generating 4-point and 6-point wavelets starts with building a 4-point wavelet based on Q=Q(α₂,α₁) (the circle leads to P automatically, given Q).

The next stage, generating a set of 6-point wavelets starts with drawing another circle with OP as diameter and drawing an inscribed rectangle ORPS, and then using OS to continue the process.

Wavelet families. The next stage, generating a set of 6-point wavelets starts with drawing another circle with OP as diameter and drawing an inscribed rectangle ORPS, and then using OS to continue the process. This provides a mechanism for increasing the number of points in the wavelet by 2 each time. The entire family is related to the first point Q and hence the angle ψ.

### Section 3

### Information Extraction, Data Compression and Post Recording Analysis Using Wavelets

This invention comprises a number of individual processes, some or all of which can be applied when using wavelets for extracting information from multi-dimensional digitised data, and for compressing the data. The invention also provides a natural context for carrying out post recording analysis as described in Section 1.

The data can take the form of any digitised data set of at least two dimensions. Typically, one of the dimensions is time, making a sequential data set. The processes are especially suitable for the treatment of digitised video images, which comprise a sequence of image pixels having two spatial dimensions, and additional colour and intensity planes of information.

In the description that follows, reference will be made to this preferred embodiment, but the processes can be applied equivalently to any multi-dimensional digitised data set.

Among the processes that are particularly relevant are the following:
a. Kernel substitution (paragraphs [00119] and [00186])
b. Adaptive wavelet representation of images (paragraphs [00109] and [00177])
c. Auto-thresholding of image differences (paragraphs [00122] and [00208])
d. Use of tailor-made templates to allow multiple methods of comparison (paragraphs [00131], [00192] and [00198])
e. Specific sets of tuneable wavelets (paragraph [0093])
f. Block scoring method for higher level discrimination and classification of detected events (paragraph [00219])
g. Use of localised threshold and quantisation levels together with controlled error diffusion to improve the perceived quality of compressed images (paragraphs [00147], [00182] and [00233]-[00238])

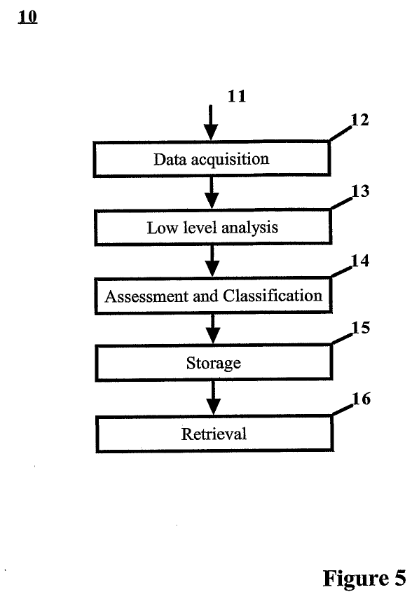

Reference will now be made in detail to an embodiment of the invention, an example of which is illustrated in the accompanying drawings. The example describes a system in which a sequence of video images is acquired, processed to extract information in the form of synoptic data, compressed, stored, retrieved, interrogated and the results displayed. An overview is presented in FIG. 5.

Wherever possible, the same reference numbers will be used throughout the drawings and the description to refer to the same or like parts.

Each image frame in the sequence undergoes wavelet decomposition. In the preferred embodiment, use is made of parameterised wavelets as described in Section 2, which aid the computation of the processes. However, any suitable wavelet representation can be used.

Hereinafter, unless otherwise stated, statements to the effect than an “image” or “frame” is processed refer to the entire wavelet hierarchy and not simply the original image.

FIG. 5 depicts the entire process from acquisition (block 12), through processing (block 13) and classification (block 14) to storage (block 15) and retrieval with queries (block 16).

In block 12, in one embodiment, temporal sequences of video images 11 are received from one or more video sources and, if required, translated to a digital format appropriate to the following steps. The data from any video source can be censored to a required frame rate. Data from a number of sources can be handled in parallel and cross-referenced for later access to the multiple streams.

In block 13 the images are subjected to low-level analysis as they are acquired. The analysis is done in terms of a series of pyramidal (multi-resolution) transforms of the image data, culminating in an adaptive wavelet transform that is a precursor to image compression.

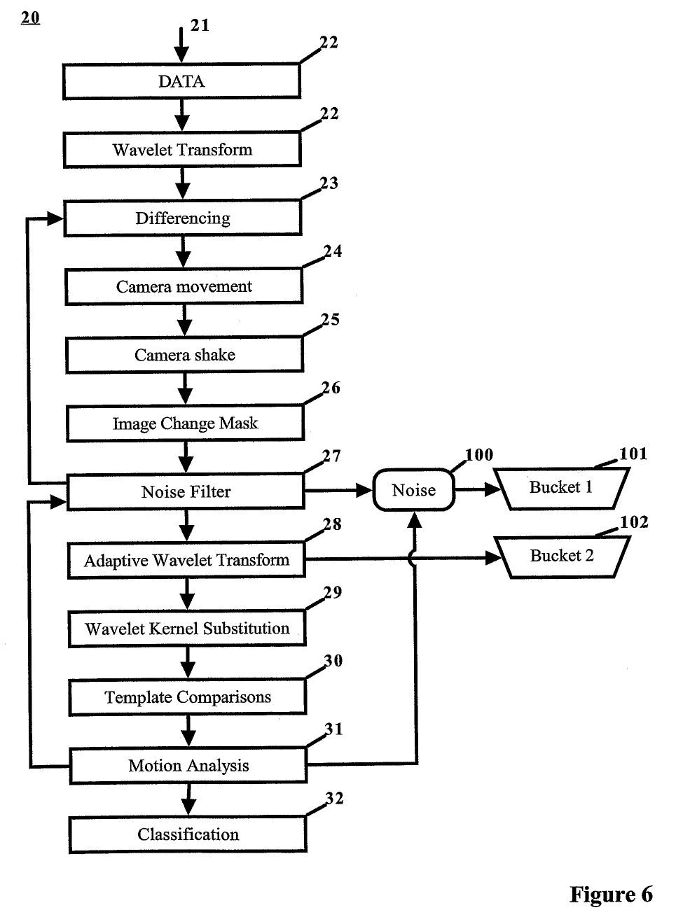

The analysis identifies and removes unwanted noise and identifies any systemic or random camera movement. It is important to deal with any noise in the colour components of the images since this is where low-end CCTV cameras are weakest. A series of processes, to be described, then identifies which parts of the image constitute either a static or a stationary background, and which parts are dynamic components of the scene. This is done independently of camera movement and independently of changes in illumination. Details are depicted in FIG. 6 and described in paragraphs [00117]-[00137]

Digital masks are an important part of the current process. Masks are coded and temporarily stored as one- or multi-level bit planes. A set of digital image masks is produced delineating the regions of the image that have different attributes. In a one-bit mask data at a point either has or has not the particular attribute. A mask encoded with more bits can store values for the attributes. Masks are used to protect particular parts of an image from processes that might destroy them if they were not masked, or to modify parts of the data selectively.

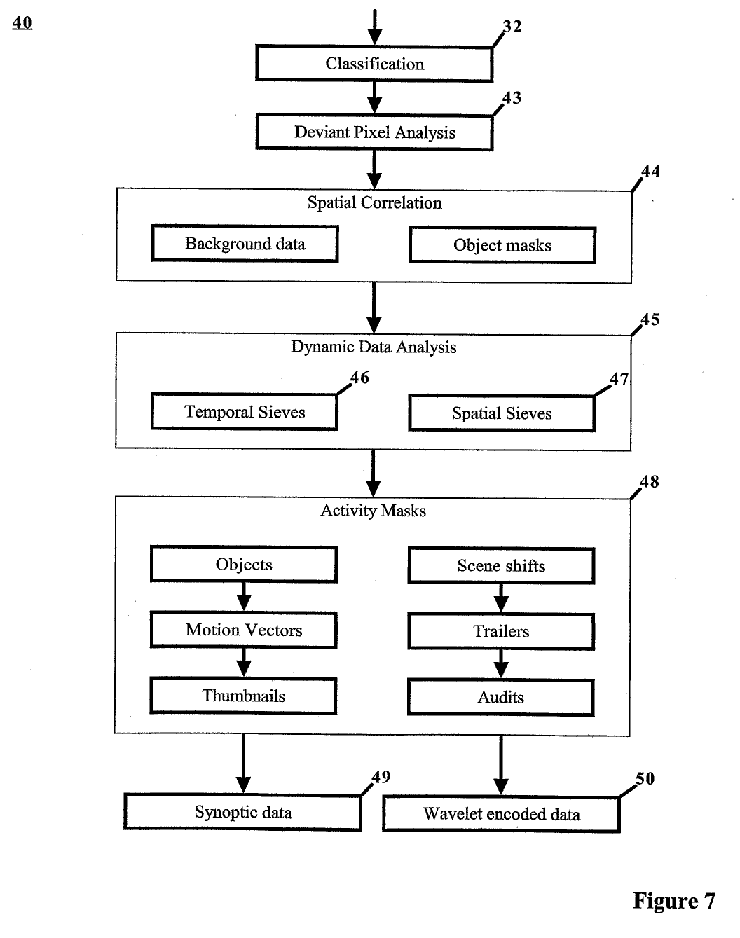

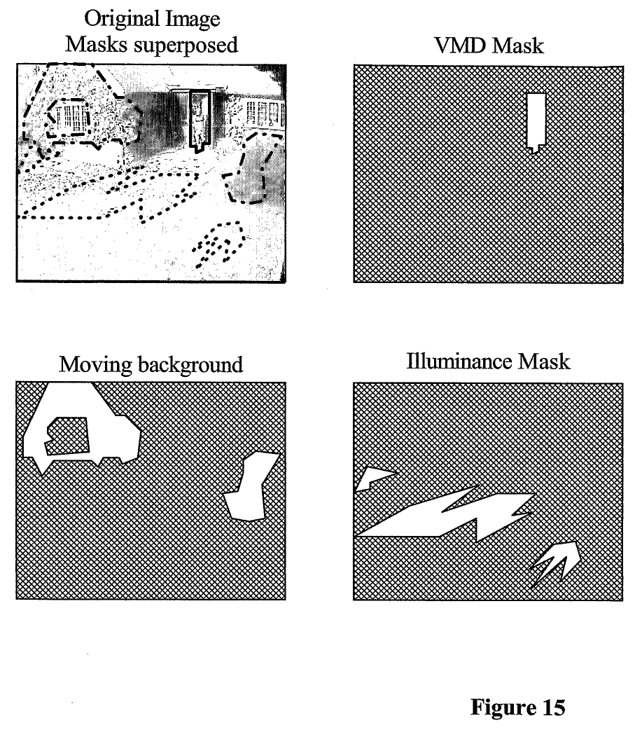

In block 14 the results of the analysis of block 13 are quantitatively assessed and a deeper analysis of the dynamical parts of the scene is undertaken. The results are expressed as a set of digital masks that will later become the synoptic data. Details are depicted in FIG. 7 and described in paragraphs [00138]-[00144] and examples of such masks are presented in FIG. 15.

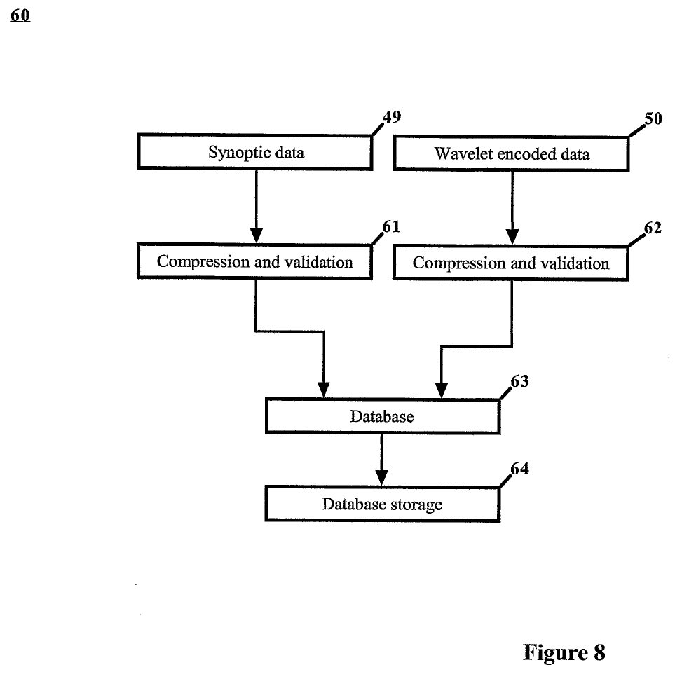

In block 15 the output of the processes described in block 14. The adaptive wavelet representations of the original scene and its associated synoptic data, are compressed and stored to disk for later retrieval. Details are depicted in FIG. 8 and described in paragraphs [00146]-[00149].

In block 16 the synoptic data stored in block 15 is queried and the any positive responses from the query are retrieved from the compressed image sequence data and displayed as events. An “event” in this sense is a continuous sequence of video frames during which the queried behaviour persists together with a plurality of related frames from other video sources. Details are depicted in Figures AE and AF and described in paragraphs [00151]-[00158].

FIG. 6 illustrates a long loop consisting of several “processing nodes” (blocks 22-31) that constitute the first phase of resolving video sequences 21 into components in accordance with the present invention.

There are a number of important features of this loop. (1): It can be executed any number of times provided the resources to do so are available. (2): Execution of the process at any node is optional, depending on time, resources and the overall algorithmic strategy. (3): The processing may take previous images into account, again depending on the availability of resources. This iterative process can be expressed as
Sⱼ=Sⱼ₋₁+Iⱼ, S₋₁=0 ([00115]).1
where Sⱼ₋₁ is the state of knowledge at the end of loop j−1, and Iⱼ is the information we are going to add to produce a new state Sⱼ at loop j.

The purpose of this loop is to split the data into a number of components: (1) Noise, (2): Cleaned data for analysis which will eventually be compressed, (3): Static, Stationary and Dynamic components of the data. Definitions for these terms are provided in the Glossary and there is more detailed discussion of this component splitting in paragraphs [00160]-[00164].

In block 21 a series of video frames is received

In block 22 each frame 21 is transformed into a wavelet representation using some appropriate wavelet. In one embodiment, for reasons of computational efficiency, a 4-tap integer wavelet having small integer coefficients is used. This allows for a computationally efficient first-pass analysis of the data.

In block 23 the difference between the wavelet transforms computed in block 22 of the current video frame and its predecessor is calculated and stored. In one embodiment of this process a simple data-point-by-data-point difference is computed. This allows for a computationally efficient first-pass analysis of the data. In another embodiment of the process a more sophisticated difference between frames is calculates using the “Wavelet Kernel Substitution” process described in detail in paragraph [00186]. The advantage of the wavelet kernel substitution is that it is effective in eliminating differences due to changes in illumination without the need for an explicit background model.

In block 24 successive frames are checked for systemic camera movement. In one embodiment this is done by correlating principle features of the first level wavelet transform of the frame difference calculated in block 23. Paragraph [00167] expands on other embodiments of this process. The computed shift is logged for predicting subsequent camera movement via an extrapolation process. A digital mask is computed recording those parts of the current image that overlap its predecessor and the transformation between the overlap regions computed and stored.

In block 25 any residuals from systemic camera movement are treated as being due to irregular camera movement: camera shake. Camera shake not only makes the visible image hard to look at, it also de-correlates successive frames making object identification more difficult. Correcting for camera shake is usually an iterative process: the first approximation can be improved once we know what is the static background of the image field (see paragraph). By their nature, the static components of the image remain fixed and so it is easily possible to rapidly build up a special background template for this very purpose. Isolating the major features of this template makes the correction for camera shake relatively straightforward. See paragraph [00167] for further details.

In block 26 those parts of the current image that differ by less than some (automatically) determined threshold are used to create a mask that defines those regions where the image has not changed relative to its predecessor. On the first pass through block 26 the threshold is computed, in one embodiment of the process, from the extreme-value truncated histogram of the difference image and in another embodiment from the median statistics of the pixel differences. The mask is readjusted on each pass. See paragraph [00168] for more technical details.

In block 27 the mask calculated in block 26 is used to refine the statistical parameters of the distribution of the image noise. These parameters are used separate the image into a noise component and a clean component.

In one iterative embodiment the process returns to block 23 in order to refine the estimates of the camera movement and noise.

When using low-cost CCTV cameras it is important to deal properly with the noise in the colour components of the signal since this is often quite substantial. Sharp edges in images are particularly susceptible to colour noise.

In block 28 the current cleaned image from block 27 is subjected to pyramidal decomposition using a novel Adaptive Wavelet Transform. In such a pyramidal decomposition of the data each level of the pyramid is constructed using a wavelet whose characteristics are adapted to the image characteristics at that level. In one embodiment the wavelets used at the high resolution (upper) levels of the pyramid are high resolution wavelets, while those used at the lower levels are lower resolution wavelets from the same parameterized family. The process is further illustrated in paragraph [00172] and in discussed in paragraphs [0093] and [0098] where various suitable wavelet families are presented.

The numerical coefficients representing this adaptive wavelet decomposition of the image can be censored, quantized and compressed. At any level of the decomposition the censoring and quantization can vary depending on (a) where there are features discovered in the wavelet transform and (b) where motion has been detected (from the motion masks of block 26 or from block 30 if the process has been iterated).

In block 29 a new version of the current image is created using low-resolution information from the wavelet transform of preceding image. This new version of the current image has the same overall illuminance as its predecessor. This novel process, “wavelet kernel substitution”, is used to compensate for the inter-frame changes in illumination. This process is elucidated in greater detail in paragraph [00186].

In block 30 the differences between the kernel-modified current image of block 29 and the preceding image are due to motion within the scene, the kernel substitution having largely eliminated effects due to changes in illumination. A digital mask can be created defining the areas where motion has been detected.

The same principle as paragraph [00129] is applied to a number of preceding images and templates that have already been stored. Various template storage strategies are available. In one embodiment of this process, a variety of different templates are stored that are 1-data-frame old (ie: the preceding data-frame), 2-frames old, 4-frames old and so on in a geometric progression. The limitation on this is due to data storage and the additional computing resources required to check a greater number of templates. There is a more detailed discussion of templates in paragraph [00192]

Templates are created in a variety of ways from the wavelet transforms of the data. The simplest template is the wavelet transform of the one previous image. In one embodiment the average of the previous m wavelet images is stored as an additional template. In another embodiment a time-weighted average over past wavelet images is stored. This is computationally efficient if the following formula is used for updating template Tⱼ₋₁ to Tⱼ using the latest image is Iⱼ:
Tⱼ=(1−α)Tⱼ₋₁αIⱼ ([00131]).1
where α is the fractional contribution of the current image to the template. With this kind of formula, the template has a memory on the order of a α⁻¹ frames and moving foreground objects are blurred and eventually fade away Stationary backgrounds such as trees with waving leaves can be handled by this smoothing effect: motion detection no longer takes place against a background of pronounced activity. (See paragraph [00164]). Obtaining such templates requires a “warm-up” period of at least α⁻¹ frames.

In another embodiment of this process a plurality of templates are stored for a plurality of α values. In some embodiments a depends on how much the image Iⱼ differs from its predecessor, Iⱼ₋₁: a highly dissimilar image would pollute the template unless a were made smaller for that frame.

Several template history masks are created reflecting the level of past activity in the noise-filtered image. The length of the history stored depends on the amount of memory assigned to each pixel of each mask and on the amount of computing power available to continually update the masks. The masks need not be kept for all levels of the wavelet transform.

In one embodiment these masks are eight bits. The “recent history mask” encodes the activity of every pixel during the previous 8 frames as a 0-bit or as a 1-bit. Two “activity level masks” encode the average rate of transitions between the ‘0’ and ‘1’ states and consecutive runlength for the number of consecutive ‘1’ over the past history. In other embodiments other state statistics will be used—there is certainly no lack of possibilities. This provides a means for encoding the level of activity at all points of the image prior to segmentation into foreground and background motions.

One or more of the activity level masks may be stored as part of the synoptic data. However, they do not generally compress very well and so in one embodiment only the lower resolution masks are stored at intervals dependent on the template update rates, α.

The current image and its pyramidal representation are stored as templates for possible comparisons with future data. The oldest templates may be deprecated if storage is a problem. See paragraph [00192] for more about templates.

In one iterative embodiment the process returns to block 27 in order to refine the estimates of the noise and the effects of variations in illumination. There are a number of important features of this loop: (1): It can be executed any number of times provided the resources to do so are available; (2): Execution of the process at any node is optional, depending on time, resources and the overall algorithmic strategy; (3): The processing may take previous images into account, again depending on the availability of resources. If iteration is used, not all stages need be executed in the first loop.

In block 31 motion analysis is performed in such a way as to take account of stationary backgrounds where there is bounded movement (as opposed to static backgrounds which are free of movement of any sort). The decision thresholds are set dynamically, effectively desensitizing areas where there is background movement, and comparisons are made with multiple historic templates. The loss of sensitivity this might engender can be compensated for by using templates that are integrated over periods of time, thereby blurring the localized movements (see paragraph [00131] and the discussions of paragraphs [00164] and [00192]).

The result is a provisional identification of the places in the wavelet transformed image where there is foreground activity. This will be refined when considerations of spatial and temporal correlations are brought to bear (see the next paragraph and paragraph [00217]).

In block 32 the image places where movement was detected in block 31 are reassessed in the light of spatial correlations between detections and temporal correlations describing the history of that region of the image. This assessment is made at all levels of the multi-resolution wavelet hierarchy. See paragraph [00219] for more about this.

FIG. 7 describes a process for temporally and spatially grouping the pixels of the dynamic foregrounds into a series of object masks that will become the synoptic data. For continuity, block 32 is taken into this diagram from FIG. 6.

In block 43 the dynamic foreground data revealed in block 31 is analysed both spatially and temporally. This assessment is made at all levels of the multi-resolution wavelet hierarchy.

In one embodiment, the spatial analysis is effectively a correlation analysis: each element of the dynamic foreground revealed in block 31 is scored according to the proximity of its neighbours among that set (block 44). This favours coherent pixel groupings on all scales and disfavours scattered and isolated pixels.

In one embodiment, the temporal analysis is done by comparing the elements of the dynamic foreground with the corresponding elements in previous frames and with the synoptic data that has already been generated for previous frames (block 44). In that embodiment the stored temporal references are kept 1, 2, 4, 8, . . . frames in the past. The only limitation on this history is the availability of fast storage.

In block 45 the results of the spatial and temporal correlation scoring are interpreted. In one embodiment this is done according to a pre-assigned table of spatial and temporal patterns. These are referred to as spatial and temporal sieves (blocks 46 and 47).

In block 48 the various spatial and temporal patterns are sorted into objects and scene shifts. For the objects motion vectors can be calculated by any of a variety of means (see paragraph [00222]) and thumbnails can be stored if desired using low-resolution components of the wavelet transform. For the scene changes, if desired, a sequence of relevant past images can be gathered from the low resolution components of the wavelet transform to form a trailer which can be audited for future reference. In one embodiment, an audit of the processes and parameters that generated these masks is also kept.

In block 49 image masks are generated for each of the attributes of the data stream discovered in block 48, delineating where in the image data the attribute is located. Different embodiments will present sets of masks describing different categories. These masks form the basis of the synoptic data. FIG. 15 illustrates three masks that describe the major changing components of a scene.

In block 50 the final version of the noise-free wavelet encoded data is available for the next stage: compression. The compression of the wavelet coefficients will be locale dependent.

FIG. 8 depicts the processes involved in compressing, encrypting and storing the data for later query and retrieval. Blocks 49 and 50 are taken over from FIG. 7 for continuity.

In block 61 the synoptic data generated in block 49 is losslessly compressed with data checksums and then encrypted should the encryption be desired.

In block 62 the adaptively coded wavelet data is compressed first by a process of locally adaptive threshold and quantization to reduce the bit-rate, and then an encoding of the resulting coefficients for efficient storage. In one embodiment, at least two locations are determined and coded with a single mask: the places in the wavelet representation where there is dynamic foreground motion and the places where there is none. In another embodiment, those places in the wavelet representation where there is stationary but not static background (eg: moving leaves) are coded with a mask and are given their own threshold and quantization.

The masks are coded and stored for retrieval and reconstruction, and image validation codes are created for legal purposes. In one embodiment, the resulting compressed data is be encrypted and provided with checksums.

In block 63 the data from blocks 61 and 62 is put into a database framework. In one embodiment this is a simple use of the computer file system, in another embodiment this is a relational database. In the case of multiple input data streams time synchronization information is vital, especially where the data crosses timezone boundaries.

In block 64 all data is stored to local or networked storage systems. Data can be added to and retrieved simultaneously. In one embodiment the data is stored to an optical storage medium (eg: DVD). A validated audit trail is written alongside the data.

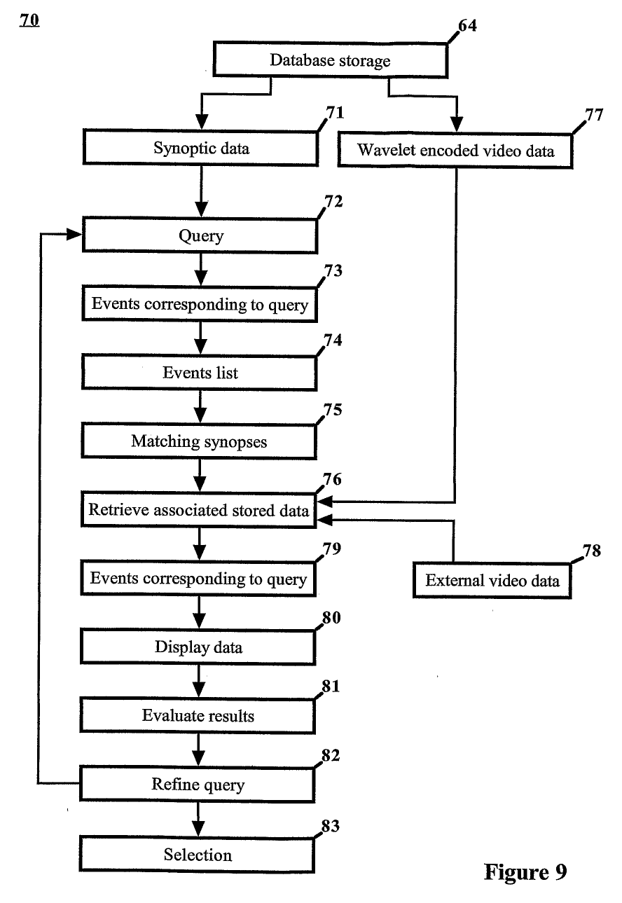

FIG. 9 shows the process of Data Retrieval in which queries are addressed about the Synoptic data, and in response to which a list is generated of recorded events satisfying that query. The query can be refined until a final selection of events is achieved. Block 64 is taken over from FIG. 8 for clarity.

In block 71 the data is made available for the query of block 72. The query of block 72 may be launched either on the local computer holding the database or via a remote station on a computer network. The query might involve one or more data streams for which there is synoptic data, and related streams that do not have such data. The query may address synoptic data distributed within different databases in a plurality of locations and may access data from a different plurality of databases in a plurality of different locations

In block 73 the Synoptic data is searched for matches to the query. A frame list matching the query is generated. We refer to these as “key frames”. In block 74 an event list is constructed on the basis of the discovered key frames.

There is an important distinction between an event and the data frames (key frames) from which it is built. An event may consist of one single frame, or a plurality of frames from a plurality of input data streams. Where a plurality of data streams is concerned, the events defined in the different streams need be neither co-temporal nor even from the same database as the key frame discovered by the query. This allows the data to be used for wide scale investigative purposes. This distributed matching is achieved in block 75. The building of events around key frames is explained in paragraph [00267].

In block 76 the data associated with the plurality of events generated in blocks 74 and 75 is retrieved from the associated wavelet encoded data (block 77), and from any relevant and available external data (block 78), and decompressed as necessary. Data Frames from blocks 77 and 78 are grouped into events (block 79) and displayed (block 80).

In block 81 there is an evaluation of the results of the search with the possibility of refining the search (block 82). Ending the search results in a list of selected events (block 83).

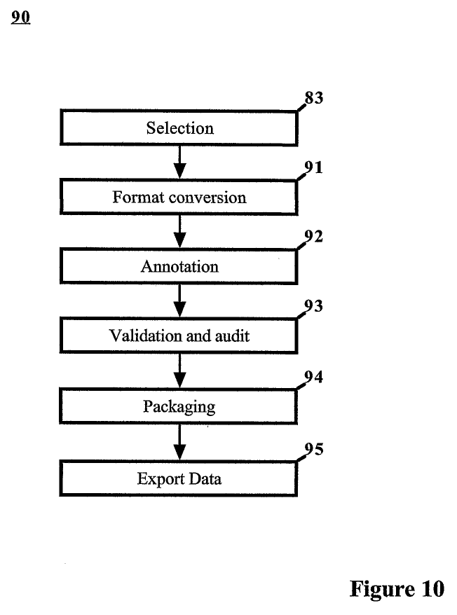

FIG. 10 shows the processes taking place after event selection (block 81, which is repeated here for clarity).

In block 91 the event data is converted to a suitable format. In one embodiment, the format is the same adaptive wavelet compression as used in storing the original data. In another embodiment, the format may be a third party format for which there are available data viewers (eg: audio data in Ogg-Vorbis format).

In block 92 the data is annotated as might be required for future reference or audit purposes. Such annotation may be text stored to a simple local database, or some third party tool designed for such data access (eg: a tool based on SGML). In block 93 an audit trail describing how this data search was formulated and executed and a validation code assuring the data integrity are added to the package.

In block 94 the entire event list resulting from the query and comprising the event data (block 79) and any annotations (block 92) are packaged for storage to a database or place from which the package can be retrieved. In block 95 the results of the search are exported to other media; in one embodiment this medium is removable or optical storage (eg: a removable memory device or a DVD).

Data Components

Noise (N) is that part of the image data that does not accurately represent any part of the scene. It generally arises from instrumental effects and serves to detract from a clear appreciation of the image data. Generally one thinks of the noise component as being uncorrelated with the image data (e.g. superposed video “snow”). This is not necessarily the case since the noise may depend directly on the local nature of the image.

Static background (S) consists of elements of the scene that are fixed and that change only by virtue of changes in camera response, illumination, or occlusion by moving objects. A static background may exist even while a camera is panning, tilting or zooming. Revisiting a scene at different times will show the same static background elements. Buildings and roads are examples of elements that make up the static background. Leaves falling from a tree over periods of days would come into this category: it is merely a question of timescales.

Stationary background (M) consists of elements of the scene that are fixed in the sense that revisiting a scene at different times will show the same elements in slightly displaced forms. Moving branches and leaves on a tree are examples of stationary background components. The motion is localized and bounded and its time variation may be episodic. Reflections in a window would come into this category. The stationary background component can often be modelled as a bounded stationary random process.

Dynamic foreground (D) are features in the scene that enter or leave the scene, or execute substantial movements, during the period of data acquisition. One goal of this project is to identify events taking place in the foreground while presenting very few false positive detections and no false negatives.

These distinctions between components ([00160]-[00163]) are practical distinctions allowing the implementer of the process to make decisions about handling various aspects of component separation. Consider a person coming into a scene, moving a chair and then walking out of the scene. The chair is a static part of the scene before it was moved and after it was placed down. While in motion, the chair is a dynamic part of the scene, as is the person moving it. This emphasizes that the separation into components varies with time and the implementation of the separation must take that into account.

There are some caveats in making these distinctions. The distinction between “static” and “stationary” backgrounds is a matter of selecting a timescale relative to which the value judgment is made. Tree branches will shake in the wind on timescales of seconds, whereas the same tree will loose its leaves over periods of weeks. The moving tree branches comprise the “moving” component of the background, while, in the absence of such motion, the loss of leaves is correctly viewed as part of the static background (albeit a slowly varying component). As it gets dark the appearance of the tree changes, but this is best regarded as a static aspect of the decomposition.

Mathematically this boils down to representing the image data G as the sum of a number of time dependent components:
G(x,t)=G^{S}(x)+G^{M}(x,εt)+G^{D}(x,t) ([00166]).1
The first component is truly static; the second is slow moving in the sense described above while the third is the dynamic component that has to be sorted into its foreground and a background contribution. Note that for the present purposes the case of systemically moving cameras is lumped into G^{S}. A more precise definition would require explicitly showing the transformations in the spatial coordinate x that results from the camera motion.
The basis for sorting G^{D} into its foreground G^{DF} and background G^{DB} components is to argue that G^{DB}, the dynamic background component, is effectively stationary:

$${\int }_{- ∞}^{T} {G}^{DB} ( \underline{x} , t ) ⅆ t \to {{G}^{⋒}}^{S} ( \underline{x} ) \qquad ( [ 00166 ] ) .2$$

for some static background [symbol] ^{S}(x) (which represents where the trees would be if they were not waving in the wind). Using a time-weighted template achieves this and allows separation of the dynamic foreground components (see paragraph [00192]).
The parameter ε determines what is meant by a slow rate of change. Ideally, e will be at least an order of magnitude smaller than the video acquisition rate. There may be several moving components, each with their own rate ε:

$$G ( \underline{x} , t ) = {G}^{S} ( \underline{x} ) + {\sum }_{i} {G}_{i}^{M} ( \underline{x} , {ɛ}_{i} t ) + {G}^{D} ( \underline{x} , t ) \qquad ( [ 00166 ] ) .3$$

The slowest of these may be lumped into the static component provided something is done to account for “adiabatic” changes of the static component.

Correcting for camera movement and camera shake in particular is an art with a long history: there are many approaches. In one embodiment the Quad Correlation method of Herriot et al. (2000) Proc SPIE, 115, 4007 is used. See Thomas et al. (2006) Mon. Not. R Astr. Soc. 371, 323 for a recent review in the astronomical image stabilization context.

First-level Noise Filter

The first estimator of the noise component is obtained by differencing two successive frames of the same scene and looking at the statistical distribution of those parts of the picture that are classified as “static background”, i.e. the masked version of the difference. The variance of the noise can be robustly estimated from
σₙ=1.483 Median(Mₙ−Mₙ₋₁) ([00169]).1
where
Mₙ=M(Fₙ−Fₙ₋₁) ([00169]).2
is the masked version of the difference between the raw frames.
On the first pass the mask is empty, (M=I, the identity), since nothing has yet been determined about the frame Fₙ.

The median of the differences is used to estimate the variance since this is more stable to outlier values (such as would be caused by perceptible differences between the frames). This is particularly advantageous if, in the interest of computational speed, the variance is to be estimated from a random sub-sample of image pixels.

Two corrections will be required for this estimate of the noise variance: (1) Correction for overall light intensity fluctuations between the scenes and (2) Correction for elements of the image that are not part of the static background. The first of these corrections is made via the “Wavelet Kernel Substitution” process (section [00186]). The second of these corrections is made via the “VMD” component of the analysis: seeing in which parts of the image there have been significant changes.

If the mask is empty (M=I) the cleaning is achieved by setting to zero all pixels in the difference image having values less than the some factor times the variance, and then rescaling the histogram of the differences so that the minimum difference is zero (“Wavelet shrinkage” and its variants).

If the mask is not empty, the value of the variance will be used to spatially filter the frame Fₙ, taking account of the areas where there have been changes in the picture and places where the filtering may be damaging to the image appearance (such as important edges).

There are several possible techniques for the feature-dependent spatial filtering among which are (1) Phase dependent Weiner-type Filtering and (2) Nonlinear feature-sensitive filters (e.g. the Teager-style Filters).

Note that the noise removal is the last thing that is done before the wavelet transform of the images are taken: noise removal is beneficial to compression.

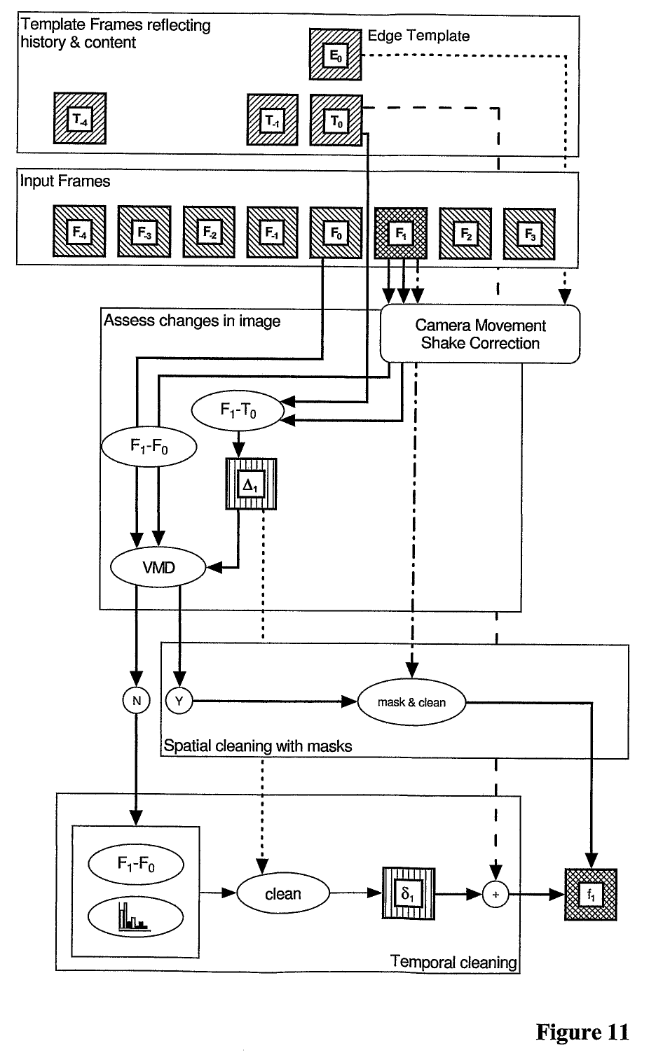

FIG. 11 synthesizes the processes that go on in the first loop through the analysis of the newly acquired picture. The figure depicts a set of frames F₀, F₋₁, F₋₂, F₋₃, . . . that have already been acquired and used to construct a series of templates T₀, T₋₁, T₋₂, T₋₃, . . . and edge feature images E₀, E₋₁, E₋₂, E₋₃, . . . . These images Eᵢ will be used for detection and monitoring of camera shake. F₀ and T₀ will become reference images for the new image F₁.

If camera shake has been detected this is corrected for at this point (see paragraph [00167]). The correction may need later refinement in a following iteration.

The (possibly shake corrected) F1 is now compared with the preceding frame, F0, and with the current template T0. The difference maps are computed and sent to a VMD detector, whereupon there are two possibilities: either there is, or there is not, any detected change in both the difference maps. This is addressed in paragraph [00168].

If there is no detected change, the noise characteristics can be directly estimated from the difference picture F1-F0: any differences must be due to noise. F1-F0 can be cleaned and added back to the previously cleaned version f0 of F0. This creates a clean version f1 of F1, which is available for use in the next iteration.

If there was a difference then the correction for the noise has to be done directly on the frame F1. The mask describing where there are differences between F1 and F0 or F1 and T0 is used to protect the parts of F1-F0 and F1-T0 where there has been change detected at this level. Cleaning these differences allows for a version f1 of F1 that has been cleaned everywhere except where there was change detected. Those regions within the mask, where change was detected, can be cleaned using a simple nonlinear cleaning edge preserving noise filter like the Teager filter or one of its generalizations.

Data Representation in Terms of Pyramidal Transforms

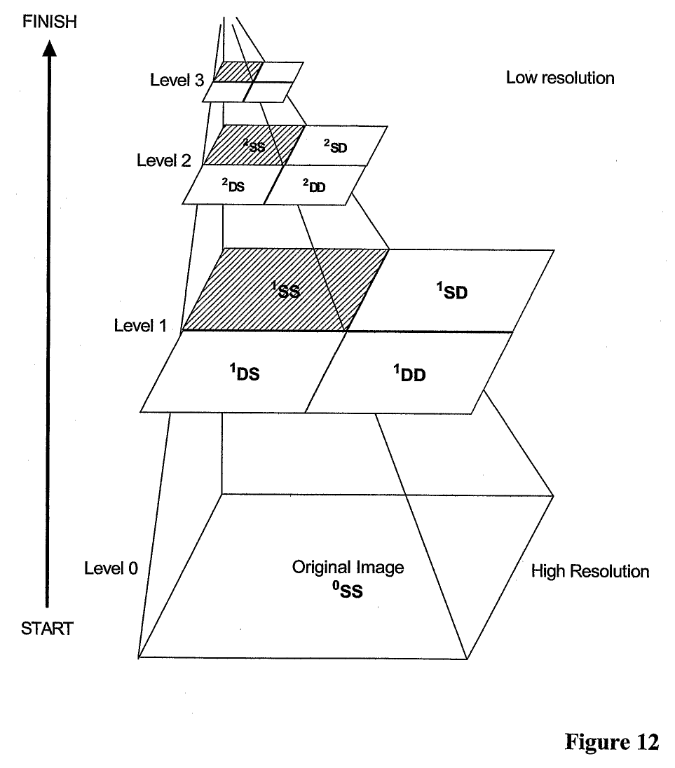

The wavelet transforms and other pyramidal transforms are examples of multi-resolution analysis. Such analysis allows data to be viewed on a hierarchy of scales and have become common-place in science and engineering. The process is depicted in FIG. 12. Each level of the pyramid contains a smaller, lower resolution, version of the original data, together with a set of data that represents the information that has to be added back to reconstruct the original. Usually, but not always, the levels of the pyramid rescale the data by a factor two in each dimension.

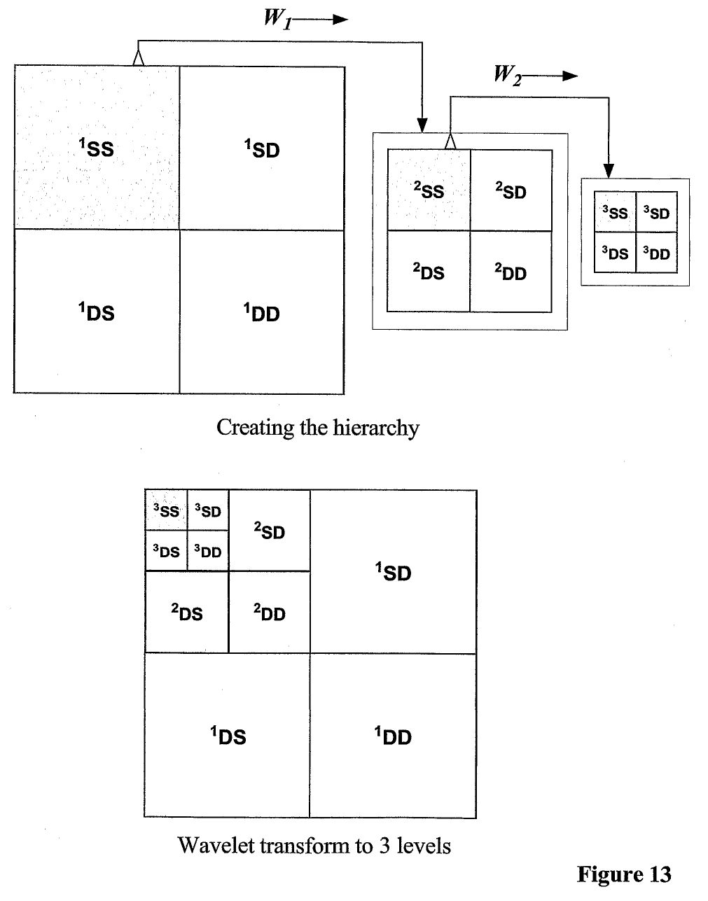

There are many ways of doing this: the way that is used here is referred to as Mallat's multi-resolution representation after the mathematician who discovered it. The upper panel of FIG. 13 shows how the hierarchy is generated first through the application of a wavelet W₁ and then with a wavelet W₂. The lower panel shows the way in which the data is stored.

The wavelet transform of a one-dimensional data set is a two-part process involving sums and differences of neighbouring groups of data. The sums produce averages of these neighbouring data and are used to produce the shrunken. Lower resolution, version of the data. The differencing reflects the deviations from the averages created by the summing part of the transform and are what is needed to reconstruct the data. The sum parts are denoted by S and the difference parts by D. Two-dimensional data is process first each row horizontally and then each column vertically. This generates the four parts depicted as {SS, SD, DS, DD} shown in the FIG. 13.

The Wavelet Hierarchy. It is usual to use the data hierarchy generated by a single, specific, wavelet chosen from the zoo of wavelets that are known. Thus in terms of FIG. 13 W₁=W₂. Common choices for wavelets in this context are various individuals from the CDF family, the CDF(2,2) variant (also known as the “5-3 wavelet”) being particularly popular, largely because of its ease of implementation.

Adaptive Wavelet Hierarchies. In the process described herein a special hierarchy of wavelet transforms is used wherein the members of the hierarchy are selected from a continuous set of wavelets parameterized by one or more values. The four-point wavelets of this family require only one parameter, while the six-point members require two, and so on. For a discrete set of parameter values, the four-point members have coefficients that are rational numbers: these are computationally efficient and accurate.

The wavelet used at different levels is changed from one level to the next by choosing different values of this parameter. We call this an Adaptive Wavelet Transform. In one embodiment of this process a wavelet having high resolution is used at the highest resolution level, while successively lower resolution wavelets are used as we move to lower resolution levels.

For any discrete wavelet, effective filter bandwidths can be defined in terms of the Fourier transform of the wavelet filter. Some have wider pass-bands than others: we use narrow pass-band wavelets at the top (high resolution) levels, and wide pass-band wavelets at the lower (low-res) levels. In one embodiment of this process the wavelets are used that have been organized into a parameterised set ordered by bandwidth.

At the lowest levels (by which we mean those levels where the transform is operating on an image that is almost the size of the original image) we are interested in preserving details and getting a good background in order to optimize the compression of those levels. At the highest levels (by which we mean those levels that have the smallest images) we are mapping large-scale structure in the image that is devoid of important features. Moreover, accuracy here is important since any errors will propagate through to the lower levels where they will be highly visible as block artifacts.

Thresholding. Thresholding the SD, DS and DD parts of the wavelet transform eliminates pixel values that may be considered to be ignorable from the point of view of image data compression. Identifying those places where the threshold can be larger is an important way of achieving greater compression. Identifying where this might be inappropriate is also important since it minimizes perceived image degradation. Feature detection and event detection point to localities (spatial and temporal) where strong thresholding is to be avoided.

Quantization. Quantization refers to the process in which a range of numbers is represented by a smaller set numbers, thereby allowing a more compact (though approximate) representation of the data. Quantization is done after thresholding and can also depends on local (spatial and temporal) image content. The places where thresholding should be conservative are also the places where quantization should be conservative.

Bit-borrowing. Using a very small set of numbers to represent the data values has many drawbacks and can be seriously deleterious to reconstructed image quality. The situation can be helped considerably by any of a variety of known techniques. In one embodiment of this process, the errors from the quantisation of one data point are allowed to diffuse through to neighbouring data points, thereby conserving as much as possible the total information content of the local area. Uniform redistribution of remainders help suppress contouring in areas of uniform illumination. Furthermore, judicious redeployment of this remainder where there are features will help suppress damage to image detail and so produce considerably better looking results. This reduces contouring and other such artifacts. We refer to this as “bit-borrowing”.

The mechanism for deployment of the remainders in the bit-borrowing technique is simplified in wavelet analysis since such analysis readily delineates image features from areas of relatively smooth data. The SD and DS parts of the transform at each level determine the weighting attached to the remainder redistribution. This makes the bit-borrowing process computationally efficient.

Wavelet Kernels, Templates and Thresholds

Wavelet kernel Substitution. This is the process whereby the large scale (low resolution) features of a previous image can be made to replace those same features in the current image. Since illumination is generally a large scale attribute, this process essentially paints the light from one image onto another and so has the virtue of allowing movement detection (among other things) to be done in the face of quite strong and rapid light variations. The technique is all the more effective since in the wavelet representation the SD, DS and DD components at each level then have only a very small DC component.

In one embodiment of this process we use the kernel substitution to improve on the first-level VMD that is done as a part of the image pre-processing cycle. This helps eliminate changes in illumination and so improves the discovery of changes in the image foreground.

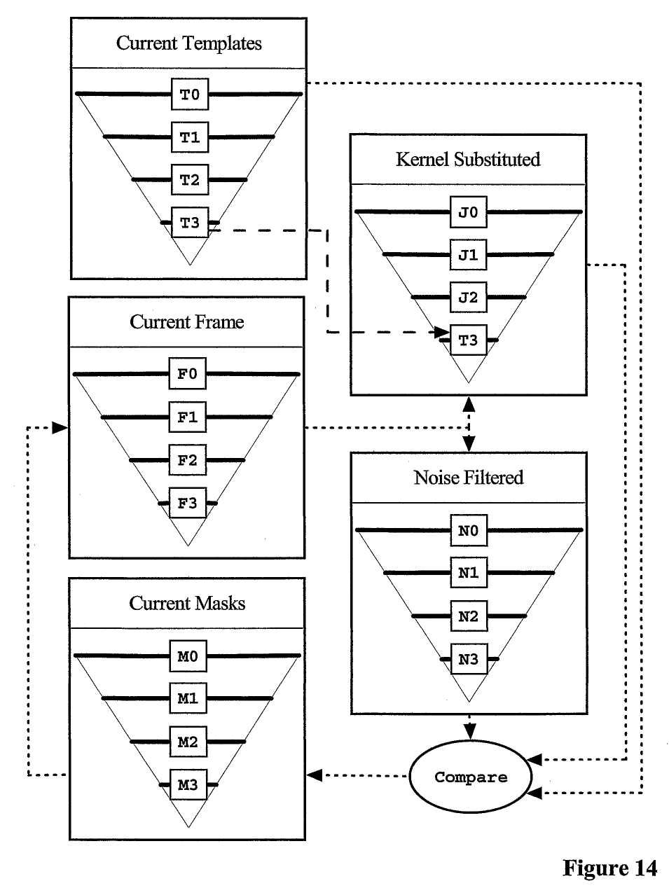

The process of wavelet kernel substitution is sketched in FIG. 14 where we see the kernel component T3 of the current template being put in place of the kernel component F3 of the current image to produce a new version of the current image whose wavelet components are Jᵢ{J0, J1, J2, T3}. This new data can be used in place of the original image Iᵢ{F0, F1, F2, F3} to estimate noise and compute the various masks.

Formally, the process can be described as follows. Let the captured images be referred to as {Iᵢ}. We can derive from this a set of images, via the wavelet transform, called {Jᵢ} in which the large-scale spatial variations in illumination have been taken out by using the kernel of the transform of the preceding image.

If we have two images {Iᵢ} and {Iⱼ) from the same sequence with wavelet transform having SS component hierarchies
{Iᵢ}={¹SS(i),²SS(i),³SS(i), . . . , ^{k}SS(i)} ([00188]).1
{Iⱼ}={¹SS(j),²SS(j),³SS(j), . . . , ^{k}SS(j)} ([00188]).2
we create the new image
{Jⱼ}={¹ S̅S̅(j),² S̅S̅(j),³ S̅S̅(j), . . . , ^{k}SS(i)} ([00188]).3
using the kernel of image i for image j.
Note the over-bars on the SS parts of the new wavelet—these are modified by the fact that we have reconstructed the image j using the i^{th} wavelet kernel. Note also that we did not modify the SD, DS or DD parts of the transform: they are used directly in the reconstruction of {Jⱼ} from ^{k}SS(i).
Then we can calculate the ambient light corrected difference between image i=j−m and j:
δ_{j,(m)}=Jⱼ−Iⱼ₋ₘ ([00188]).4
This difference image represents the changes in the image since the image m frames ago was taken, over and above any changes due to ambient lighting.
There is an issue of whether to update the kernel of imagej with that of j−m, or vice versa. In practise computational efficiency causes us to do the substitution as described since we always have the entire wavelet transform of the current image cached in memory.

Relative Changes. In practice it is possible to look only at the changes at a single level p of the wavelet transform:
δ_{j,(m)}^{p}=^{p} S̅S̅(j)−^{p}SS(i), m=j−i ([00189]).1
This describes the difference between the SS part of the p^{th} level of the kernel substituted wavelet transform of the current image, j, with the corresponding part of the wavelet transform of image i. The value of the lag m depends simply on the frame rate and in practice turns out to be a fixed length of time over which motion changes are perceptible. However, doing this loses the size-discrimination that comes naturally with multi-resolution analysis and it is always better to use the entire transform if possible.

Current image. It is usual to think of the current image as simply being a single image that we wish to evaluate relative to its predecessors. This is usually the case. However, there are embodiments of this process in which it might be useful to replace the single current image with an average of a selection of preceding images.

Elimination of transients. In the application of environmental monitoring it is not useful to have the images polluted by transient phenomena such as animals, people and vehicles. Using data that is a suitably time-weighted average over a set of recently past images will eliminate these transients. We can refer to this data as the “current transient-eliminated image”.

In one embodiment of this process that has been adapted to such a situation the following formula is used for defining and updating the “current transient-eliminated image” Cⱼ₋₁ to Cⱼ using the latest single image is Iⱼ:
Cⱼ=(1−τ)Cⱼ₋₁+τIⱼ ([00191]).1
where τ is the fractional contribution of the current image to the template. With this kind of formula, the image retains information on the order of τ¹ frames. In this application the templates would be stored over a period of time significantly longer than τ−¹ frames (days or even weeks, as opposed to minutes).

Templates and Masks

Templates. Throughout the processes described herein a variety of what might be called “image templates” is stored on a temporary basis. Generally, the templates are historical records of the image data themselves (or their pyramidal transform) and provide a basis for making comparisons between the current image and preceding images, either singly or in combinations. Such templates are usually, but not always, constructed by co-adding groups of previous images with suitable weighting factors (see paragraph [00198]).

A template may also be a variant on the current image: a smoothed version of the current image may, for example, be kept for the process of unsharp masking or some other single-image process.

Masks. Masks, like templates, are also images, but they are created so as to efficiently delineate particular aspects of the image. Thus a mask may show where in the image, or its pyramidal transform, there is motion above some threshold, or where some particular texture is to be found. The mask is therefore a map together with a list of attributes and their values that define the information content of the map. If the value of the attribute is “true or false”, or “yes or no”, the information can be encoded as a one-bit map. If the attribute is a texture, the map might encode the fractal local dimension as a 4-bit integer, and so on.

When a mask is applied to the image from which it was derived, the areas of the image sharing particular values of the mask attribute are delineated. When two masks having the same attributes are applied to a pair of images, the difference between the masks shows the difference between the images in respect of that attribute.

Information from one or more masks goes towards building Synoptic Data for the data stream. The synopsis reflects the attributes that defined the various maps from which it is built. FIG. 15 illustrates three level-0 masks corresponding to dynamic foreground and static and stationary background components that are to be put into the synoptic data stream.

In this figure the VMD Mask reveals an opening door and a person walking out from the door. The moving background mask indicates the location of moving leaves and bushes. The illuminance mask shows where there is variations in the lighting due to shadows from moving trees. (This last component does not appear as part of the moving background since it is largely eliminated by the wavelet kernel substitution).

Specific Templates. Templates are reference images against which to evaluate the content of the current image or some variant on the current image (sections [00190] and [00191]). The simplest template is just the previous image:
Tⱼ=Iⱼ₋₁ ([00198]).1
Slightly more sophisticated is an average of the past m images:

$${\overline{T}}_{j} = \frac{1}{m} {\sum }_{k = 1}^{m} {I}_{j - k} \qquad ( [ 00198 ] ) .2$$

which has the virtue of producing a template having reduced noise. More useful is the time-weighted average over past images:
\tilde{T}ⱼ=αIⱼ+(1−α)\tilde{T}ⱼ₋₁ ([00198]).3
where α is the fractional contribution of the current image to the template. This last equation can alternatively be solved as

$${\tilde{T}}_{n} = α {\sum }_{r = 0}^{n} {( 1 - α )}^{r} {I}_{n - r} \qquad ( [ 00198 ] ) .4$$

showing \tilde{T}ₙ as a weighted sum of past frames with the frame r images previously having weighting factor α(1−α)^{r}. With this kind of formula, the template has a memory on the order of a α⁻¹ frames and so obtaining this template requires a “warm-up” period of at least α⁻¹ frames.

In practise, α may depend on how much the image Iⱼ differs from its predecessor, Iⱼ₋₁: a highly dissimilar image would pollute the template unless α were made smaller for that frame. The flexibility in choosing α is used when a dynamic foreground occlusion would significantly change the template (see [00213]).

Recent history mask. The “recent history mask” encodes the activity of every pixel during the previous 8 frames as a 0-bit or a 1-bit.

Activity Level masks. Two “activity level masks” encode the average and variance of the number of consecutive ‘ones’ over the past history and a third recent activity mask encode the length of the current run of ‘ones’.

Other templates: Note that we are not restricted to the predecessors of Iⱼ when building templates. It is for some purposes useful to consider templates based on future images such as
\dot{T}ⱼ=Iⱼ₊₁−Iⱼ₋₁ ([00201]).1
or even

$${\ddot{T}}_{j} = \frac{1}{2} ( {I}_{j + 1} - 2 {I}_{j} + {I}_{j - 1} ) \qquad ( [ 00201 ] ) .2$$

As the notation suggests, these are estimators of the first and second time derivatives of the image stream at the time image Iⱼ is acquired. Using such templates involves introducing a time lag by buffering the analysis of the stream while the “future” images are captured.
There are numerous other possibilities. The Smoothed image template
Sⱼ=Smooth(Iⱼ) ([00201]).3
where “Smooth” represents any of a number of possible smoothing operators applied to the image Iⱼ. The Masked image template [symbol]
=Mask(Tⱼ) ([00201]).4
where the “Mask” operator applies a suitably defined image mask to the template image Tᵢ. The list is obviously far from exhaustive, but merely illustrative.

Recent History mask. The “recent history masks” encode some measure of the activity of every pixel in the scene during the previous frames. One measure of the activity is whether a pixel difference between two successive frames or between a frame and the then-current template was above the threshold defined in paragraph [00214].

In one embodiment this stored as an 8-bit mask the size of the image data, so the activity is recorded for the past 8 frames as a ‘0’ or a ‘1’. Each time the pixel difference is evaluated this mask is updated by changing the appropriate bit-plane.

Longer-term history masks. Like the Recent History masks these encode historical data from previous scenes. The difference is that such masks can store the activity data at fiducial instants in the past. Uniformly spaced points are easy to update but not as useful as geometrically spaced points that are harder to update. Such masks facilitate the evaluation of long-term behaviour in respect of scene activity.

Activity Level masks. Two “activity level masks” present a statistical summary of the activity at a given pixel as presented in the Recent History mask. The entries in the first of these masks records the number or rate of state changes undergone by that pixel. This is easiest kept as a running average so that if the rate was Rⱼ₋₁ and the next change is eⱼ=0 or 1, then we update the estimator of the rate R to
Rⱼ=εRⱼ₋₁+(1−ε)eⱼ ([00204]).1
The number ε reflects the span of data over which this rate is averaged.
The second mask keeps a tally of the mean length of runs where eⱼ=1: the “activity runlength”. This must be calculated the same way as the rate estimator, so if the rate is an ε-average as above, so must be the activity runlength.

These activity masks are quite expensive to maintain and so, in some embodiments, it may be convenient to restrict the mask to a smaller level of the data pyramid and those even smaller levels above it. Typically, keeping a maximum of one half the resolution of the main image is found to be perfectly adequate; this is level 1 or Level 2 in FIG. 12.

Background change mask—non-motion detection. There are two important questions that can be asked about the static background (which should not, by definition, change). Is there something in what is normally regarded as part of the static background that is no longer there? Conversely, is there now something that is part of the static background that was not there before? Clearly this kind of change would require that there have been some movement in the scene to cause the change. However, the question is more complex than merely asking to find a change. The question is whether the static background is ever restored, and if so, when?

The masks that record foreground motion cannot handle this, so a special background change mask must be used that enables the identification of features in the static background through comparison or correlation. This mask will remain constant if the static background component does not change, except in those places occluded by dynamic foreground objects. Hence the differences between static background masks will, in the ideal world, be zero and cost nothing to store.

An ideal mask for this purpose is the sum of the SD and DS parts of level 1 of the wavelet pyramid (See FIG. 12) since that maps the features in the scene with relatively high resolution. Differencing two successive such masks constructed from their kernel substituted wavelet representations allows this comparison to be made provided we also have access to the corresponding dynamic component masks. With the latter we can eliminate features that correspond to moving parts of the scene.

The resulting background change mask can be compressed and stored as part of the synoptic data/

Differences Between Images

Difference Images. For the purposes of this section we shall consider the word “image” to refer to any of the following. (1) An image that has been captured from a data stream, (2) An image that has been captured from a data stream and subsequently processed. In this we even include transforms of the image such as a shrunken version of the image or its Wavelet Transform. (3) Part of an image or one of its transforms.

In other words, we are considering the comparison of an array of data taken from a stream of such arrays with its predecessors.

We shall denote the j^{th} such array in the stream by the symbol Iⱼ and the object relative to which we make the comparison (the “template”) by the symbol Tⱼ. Tⱼ can be any of the various templates that may be defined from other members of the stream Iⱼ (see section 0).

We consider how to evaluate the differences between an image and any of these various templates. Consider the difference image
δⱼ=Iⱼ−Tⱼ ([00210]).1
The mean of the pixels making up δⱼ need not be zero unless all the images making up the template Tⱼ and the image Iⱼ are identical. This is an important point when considering the statistics of the pixel values of δⱼ.
On average the values of the pixels in the image δⱼ is zero if the ambient light changes are such that the kernel substitution ([00186]-[00188]) is effective. When the pixels are not zero we have to assess whether they correspond to real changes in the image or whether they are due to statistical fluctuations.

Deviant pixels. Here we concentrate on tracking, as a function of time, the values of pixels in the difference images. The criteria we develop use the time series history of the variations at each pixel without regard to the location of the pixel or what its spatial neighbours are doing. This has the advantage that non-uniform noise can be handled without making assumptions about the spatial distribution of the noise. The spatial distribution of this variation will be considered later (see paragraph [00217]).

In one embodiment of this process the time history of each pixel in the data is followed and modeled. From this history a pixel threshold level Lᵢ is defined in terms of a quantity that we might call the “running discrimination level”, Mᵢ, for the random process describing the history of each pixel.

Suppose that for difference image δᵢ we were able to determine a threshold level Lᵢ above which we believed (according to some statistical test) that the pixel value might not be due to noise: a “deviant pixel value”. Then we might decide that in the difference image δⱼ we would deem a pixel having value Δⱼ deviant if it had
|Δⱼ|>λLᵢ ([00212]).1
for some safety factor λ. (We recognize that for a skewed distribution of the pixel values in δⱼ we might choose to have different bounds for positive and negative values of Δ; however, for the sake of notational simplicity we assume that these are the same).
Because the changes Δⱼ in the pixel values are a non-stationary random process, the value of Lᵢ should reflect the upper envelope of the |Δⱼ| values. Upper envelopes are notoriously hard to estimate for such processes and so we have to resort to some simplified guesses. This is especially true since this has to be done for every pixel and there is a computing time constraint.

Discrimination level. Consider the m previous values of Δⱼ, using these values compute, for each pixel, a discrimination level Mⱼ based on a formula such as any of the following:
Mⱼ=max {|Δⱼ₋₁|,|Δⱼ₋₂|,|Δⱼ₋₃|, . . . , |Δⱼ₋ₘ|}
Mⱼ=mean {|Δⱼ₋₁|,|Δⱼ₋₂|,|Δⱼ₋₃|, . . . , |Δⱼ₋ₘ|}+κ
Mⱼ=β|Δⱼ₋₁|+(1−β)Mⱼ₋₁ ([00213]).1
The first of these is a direct attempt to get the envelope by looking at the signal heights in a moving m-time-interval window. The second simply uses the mean of the modulus of the last m signal heights together with a safety margin κ. The last of these is a time-weighted average of the previous signal heights, the quantity β reflecting the relative time weighting. It is the preferred mechanism.

Pixel Threshold Level. Given the discrimination level as defined above ([00213]), we may compute the pixel threshold level Lⱼ, for each pixel as follows. Set the threshold for that pixel to be
Lⱼ=αLⱼ₋₁+(1−α)Mⱼ ([00214]).1
for some “memory parameter” α. Note that α is not the same as the quantity β entering into the calculation of the discrimination level Mⱼ (the third of equations [00213].2). We then make the comparison to decide whether or not to “mark” the pixel as being deviant and reset the value of Lⱼ for the next frame calculation according to whether or not the pixel was deviant:

$${L}_{j} = \{ \begin{matrix}{L}_{j} , & if {Δ}_{j} > λ {L}_{i} , \\ {M}_{j} & otherwise\end{matrix} \qquad ( [ 00214 ] ) .2$$

In other words, we do not update the threshold for the pixel if that pixel was deemed deviant. This avoids the bias that might be introduced by allowing threshold to be determined by anomalous circumstances. If our acceptance criterion were based on 3σ deviations, for example, this procedure would simply be equivalent to 3σ rejection in calculating the threshold.

Compensating for moving backgrounds. What this procedure does is to allow the threshold to ride over the noise peaks. For a known probability density for the noise distribution the levels can be adjusted so that there is a known probability that a pixel will falsely be deemed to be deviant. In the absence of a known probability density of the distribution of the pixel differences the decision can be made non-parametrically using standard tests of varying degrees of sophistication.

The net effect of a moving background is to de-sensitise the detection of motion in areas where the scene is changing in a bounded and repetitive way. This might happen, for example, where shadows of trees cast by the Sun were moving due to wind movement: the threshold would be boosted because the local variance of the image differences is increased.

This is an important mechanism for avoiding cascades of false alarms in video detection systems. The downside of this is that a supplementary detection mechanism may be required under these circumstances since the desensitisation creates a danger of missing important events. In one embodiment this is solved by using templates that have relatively long memories since such templates blur out and absorb such motions. Image comparison is against a background that is relatively free of sharp moving background features (see paragraphs [00164] and [00192]).

The parameters. In the embodiment just described there are several parameters that must be set for detection of significant changes within an image stream. Some of these parameters are fixed at the outset, while others will vary with the ambient conditions and are “learned”.

We can identify several parameters that have to be set or determined when using the previously described procedure:

m

This is the lag in frames for making the comparison. Clearly at 25 frames per second m will be larger than for 3 frames per second. It is obvious that had we undersampled the 25 frames per second sample at 3 frames per second we would end up using the same value of m. Hence m is directly proportional to the frame rate. The value of the proportionality constant depends on how fast the motion being sought is in terms of the frame traversal speed.

λ

This is the sensitivity of the detection at a given pixel: how anomalous the observed value of the pixel change is in relation to the values previously observed. Note that we use a maximum criterion, rather than a mean or standard deviation, in order to test pixel values. λ is related to the first order statistic in the sample of non-deviant values.

α

The memory factor telling how much of the past history of thresholds we take into account when updating the value of the threshold for the next frame. This is related to the frame capture rate since it reflects the span of time over which the ambient conditions are likely to change enough as to make earlier value of the threshold irrelevant.

These parameters are set with default values and can be auto-adjusted after looking at 10 or so frames. This is a relatively short “teaching cycle”, though the learning method need not be any more sophisticated (one could imagine taking the statistics of the noise over a period of time and doing a calculation—this works but in practice is hardly worth the effort).

Deviant Pixel Analysis. The embodiment just described generates, within an image, a set of deviant pixels: pixels for which the change in data value has exceeded some automatically assigned threshold. Until this point, the location of the pixels in the scene was irrelevant: we merely compared the value of the changes at a given pixel with the previous history at that point. This had the advantage of being able to handle spatially non-uniform noise distributions.

The issue now is to decide whether they are likely to represent a genuine change in the image, or simply be a consequence of statistical fluctuations in the image noise and ambient conditions. In order to help with this we look at the coherence in the spatial distribution of the deviant pixels.

Spatial correlations of deviant pixels. If in an image we find, for example, ten deviant pixels we would be more impressed if they were clustered together than if they were randomly distributed throughout the image. Indeed, we could compute the probability that we would get ten deviant pixels distributed at random if we knew the details of the noise distribution.

Block scoring. Here we present one embodiment of a simple method for assessing the degree of clustering of the deviant pixels by assigning a score to

| | |
|---|---|
| Deviant pixel | Score 2 |
| Each horizontal or vertically attached neighbour | Score 2 |
| Each diagonally attached neighbour | Score 1 |

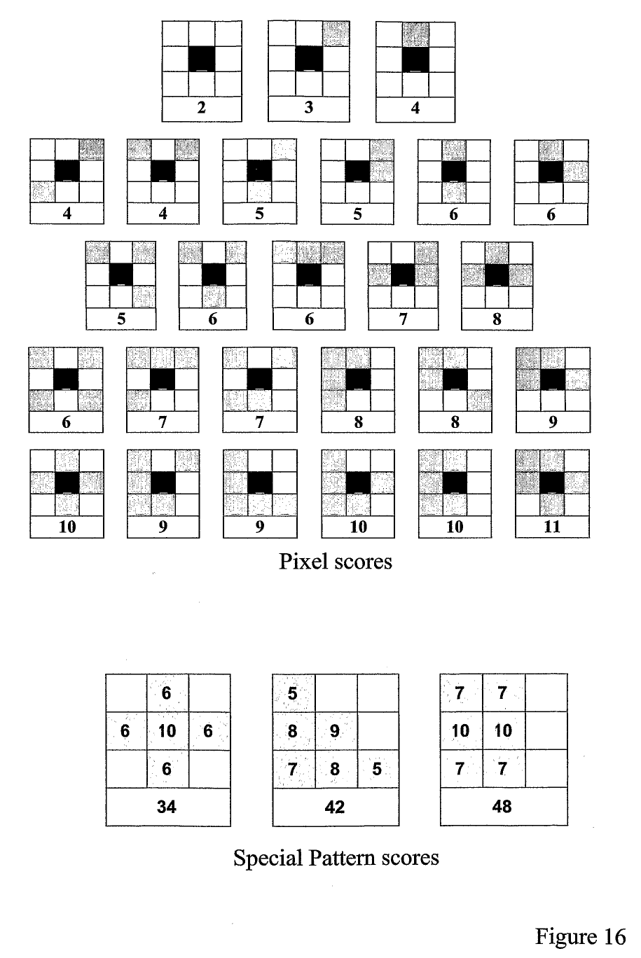

each deviant pixel depending on how many of its neighbors are themselves deviant.
A number of 3×3 patterns, with the scores assigned to the central pixel, are shown in the “Pixel Scores” panels of FIG. 16.
The score rises rapidly as the number of neighbours increases, though there appears, at first sight, to be some slight anomalies wherein one pattern seems to score less than some other pattern that one might have thought less significant. A horizontal-vertical cross of 5 pixels scores 10, while a diagonal of 6 pixels only scores 9 (patterns 1 and 3 in the last row).
The situation resolves itself when one looks at the overall pattern score, that is, the total score for all deviant blocks in a given region. The “Special Pattern Scores” panel of FIG. 16 illustrates the total deviant pixel scores in some 3×3 blocks, where it has been assumed that the 3×3 block is isolated and does not have any abutting deviant pixels. There is a nonlinear mutual reinforcement of the block scores and so the tile score is boosted if the block pattern within the 3×3 region is tightly packed.

In one embodiment blocks are weighted so as to favor scoring horizontal, vertical or diagonal structures in the image. This is the first stage of pattern classification. Clearly this process could be executed hierarchically: the only limitation on that is that doing so doubles the requirement on computational resources.

As a final comment it should be noted that the Synoptic image of the deviant pixels does not need to store the pixel scores: these can always be recalculated whenever needed provided the positions of the deviant pixels are known. Thus the Synoptic Inage reporting the deviant pixels is a simple one-bit-plane bitmap: equal to 1 only if the corresponding pixel is deviant, 0 otherwise.

It is this that makes the searching of Synoptic data for picture changes so fast.

Motion Vectors.

Calculating motion vectors is an essential part of many compression algorithms and object recognition algorithms. However, it is not necessary to use the motion vectors for compression unless extreme levels of compression are required.

We use motion vectors to identify and track objects in the scene. The method used is novel in that it is neither block based nor correlation based. The method benefits from the use of the wavelet kernel substitution technique ([00186]-[00188]) that, to a sufficient extent, eliminates systemic variations in the illumination of the background. (Background illumination issues are well known to be an issue with optical flow calculations.)

The present description applies to the {^{j}SS} components of the kernel substituted wavelet transform. For each wavelet level we produce the logarithm of the pixel values in each {^{j}SS} component. In order to avoid zero and negative values (the latter can occur as a consequence of the wavelet transform) we add a level dependent constant offset to the pixel values so that all values are strictly positive.
^{j}ρ=ln(^{k}κ+^{j}g), ^{j}gε{^{j}SS} ([00224]).1
All images used in the calculation get the same offsets. The logarithmic pixel values are kept as floating point numbers, but in the interests of calculation speed they could be rescaled to 4 or 5 bit signed integers.
In order to evaluate the time derivatives of ^{j}ρ we need {^{j}SS} at three instants of time: the current time and the time of the previous and next frames. We shall denote the data values at these instants with subscripts −1, 0 and +1. Thus

$$\begin{matrix}{\dot{ρ}}_{0} = ( {ρ}_{1} - {ρ}_{- 1} ) \\ and & ( [ 00224 ] ) .2 \\ {\ddot{ρ}}_{0} = \frac{1}{2} ( {ρ}_{1} - 2 {ρ}_{0} + {ρ}_{- 1} ) & ( [ 00224 ] ) .3\end{matrix}$$

For each of these fields we compute new, highly smoothed, fields

$$\begin{matrix}ϕ ( x ) = {\sum }_{neighbors i} {w}_{i} {\dot{ρ}}_{0} ( {x}_{i} ) \\ and & ( [ 00224 ] ) .4 \\ Φ ( x ) = {\sum }_{neighbors i} {w}_{i} {\ddot{ρ}}_{0} ( {x}_{i} ) & ( [ 00224 ] ) .5\end{matrix}$$

The weight factors wᵢ are the same for both equations. The weights are chosen so that these potential fields are approximate solutions of the Laplace equation with sources that are the first and second time derivatives of ρ, the logarithmic density.
The velocity field is calculated using spatial gradients of these potentials on all scales of the wavelet transform.

Note that at low frame rates the first derivative field, φ, may produce a zero result even though there was an intrusion. This is because the image fields on either side could be the same if the intrusion occurred only in the one current frame. However, this would be picked up strongly in the second derivative field, Φ. Conversely, a slow uniformly moving target could give a zero second derivative field, Φ, but this would be picked up strongly in the first derivative field, φ.

Note that both fields are likely to be zero or close to zero where the deviant pixel analysis shows no change. There must be a change in order to measure a velocity!

Compression and Storage

Wavelet encoded data. At this stage the data stream is encoded as a stream of wavelet data, occupying more memory than the original data. The advantage of the wavelet representation is that it can be compressed considerably. However, the path to substantial compression that retains high quality is not at all straightforward: a number of techniques have to be combined.

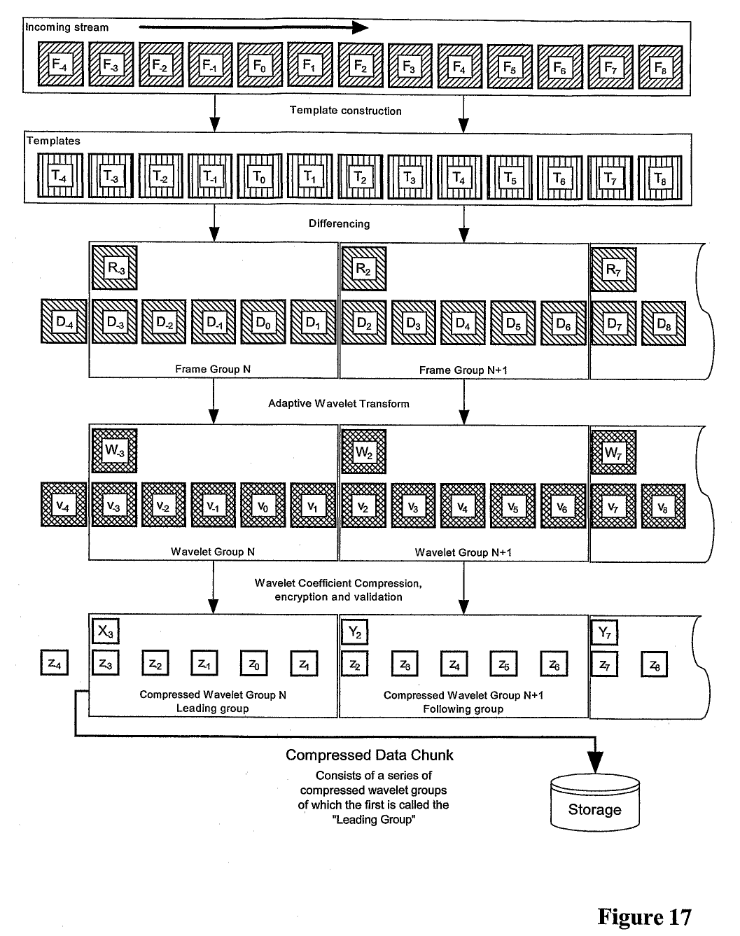

Data structure. FIG. 17 summarizes the elements of the data compression process. The original image data stream consists of a set of images {Fᵢ}. These are built into a running sequence of templates {Tᵢ} against which various comparisons will be made. From these two streams, images and templates, another stream is created—a stream of difference pictures {Dᵢ}.

The differences are either differences between neighboring frames, or between frames and a selected template. By “neighboring” we do not insist that the neighbour be the predecessor frame: the comparison may be made with a time lag that depends on frame rate and other parameters of the image stream.

For a discussion on the variety of possible templates see paragraphs [00131] et seq. and [00193] et seq. See also paragraphs [00131] and [00191] regarding alternatives to using the “current frame”. The discussion can continue referring to frames and templates without loss of generality, recognizing that there are these other possible embodiments of the principle.

We refer to the partner in the differencing process as a Reference image {Rⱼ}. In other words, Rⱼ could be one of the Tᵢ or one of the Fᵢ.

The object of compression is the data stream consisting of the data {Dᵢ} and {Rⱼ}. Both these streams are wavelet transformed using an appropriate wavelet or, as in our case, a set of wavelets. Wavelets may be floating point or integer, or a mixture of both. Symbolically we can write:
Fₖ=Rᵢ+Dₖ ([00229]).1
It is an important question as to how many of the Dₖ should be used with a given Rⱼ. In principle we would need only one reference image, R₀. However, a very long sequence would be disadvantageous because (a) the Dₖ would become larger as future frames differed more from the reference and (b) decompressing a late Dₖ would involve handling a very long sequence of data.

By their very nature, the individual {Dᵢ} will compress far more than the reference frames {Rⱼ}. This situation can itself be helped by differencing the {Rⱼ} among themselves and then representing the sequence {Rⱼ} as a new sequence {Rⱼ, {δ_{k}} so that}
Rₖ=Rᵢ+δₖ ([00230]).2
Because of the prior similarity of members of the sequence {Rⱼ}, δₖ can be represented in fewer bits than Rₖ. The compression of the {Rⱼ} is a central factor in determining the quality of the restored images. The compression of the {δₖ} sequence must be done almost losslessly, since losses are equivalent to lowering the quality of the restored Rₖ=Rⱼ+δₖ. The data stream to be compressed can be represented as
{{Rᵢ,Dᵢ,Dᵢ₊₁, . . . , Dᵢ₊ₘ₋₁},{δₖ,Dₖ,Dₖ₊₁,Dₖ₊ₘ₋₁}, . . . , }, k=m+i
FIG. 17 shows schematically how the differencing is organized.

The final stage is to take the wavelet transform of everything that is required to make the compressed data stream:
Rₖ→Wₖ
Dₖ→Vₖ ([00231]).3a
and, if we re-organize the reference frames:
δₖ→ωₖ ([00231]).3b
The wavelet transform stream is then
{{Wᵢ,νᵢ,νᵢ₊₁, . . . , νᵢ₊ₘ₋₁},{ωₖ,νₖ,νₖ₊₁, . . . , νₖ₊ₘ₋₁}, . . . , }, k=m+i
for some cycle length, m. Note that no compression has yet taken place.

Each data block in the wavelet data stream consists of a series of arrays of wavelet coefficients:
νⱼ={¹Qⱼ,²Qⱼ, . . . , ^{K}Qⱼ}, ([00232]).4
where
^{N}Qⱼ={^{N}SS,^{N}DS,^{N}SD,ⁿDD} ([00232]).5
is the wavelet transform array at level N, and likewise for the transforms Wᵢ and ωₖ. of the reference images and their differences. The smallest of these arrays, appearing as wavelet level K, contains a small version of the image: the so-called “wavelet kernel”. In the present notation the wavelet kernel is
Data wavelet kernel=^{K}SS ([00232]).6

Compression. The transforms of each of the different types of frame, reference frames Rᵢ, difference frames Dᵢ or differenced references δᵢ, requires its own special treatment in order to maximize the effectiveness of the compression while maintaining high image quality.

Here we recall the generic principles only: that the process consists of determining a threshold below which coefficients will be set to zero in some suitable manner, a method of quantizing the remaining coefficients and finally a way of efficiently representing, or encoding those coefficients.

Adaptive coding. We recall also that different regions of the wavelet planes can have different threshold and quantization: each region of the data holding particular values of threshold and quantization is defined by a mask. The mask reflects the data content and is encoded with the data.

Suppose a part of the image is identified as being of special interest, perhaps in virtue of its motion or simply because there is fine detail present. It is possible, for these areas of special interest, to choose a lower threshold and a finer degree of quantization (more levels). A different table of coefficient codes is produced for these areas of special interest. One can still use the shorter codes for the more populous values; the trick is to keep two tables. Along with the two tables it is also necessary to keep two values of the threshold and two values of the quantization scaling factor.

Thresholding. Thresholding is one of the principal tools in controlling the amount of compression. At some level the thresholding removes what might be regarded as noise, but as the threshold level rises and more coefficients are zeroed, image features are compromised. Since the SD, DS and DD components of the wavelet transform matrix measure aspects of the curvature of the image data, it is pixel scale low curvature parts of the image that suffer first. Indeed, wavelet compressed images have a “glassy” look when the thresholding has been too severe.

Annihilating the ^{j}SD, ^{j}DS and ^{j}DD components of the wavelet transform matrix results in an image ^{j-1}SS that is simply a smooth blow-up of the ^{j}SS component and doing this on more than one level produces featureless images.

The rule of thumb is that the higher levels (smaller arrays) of the wavelet must be carefully preserved, while the lower levels (bigger arrays) can be decimated without too much perceived damage to the image if thresholding is done carefully.

Quantization. Quantization of the wavelet coefficients also contributes to the level of compression by reducing the number of coefficients and making it possible to encode them efficiently. Ideally, quantization should depend on the histogram of the coefficients, but in practice this places too high a demand on computational resources. The simplest and generally efficient method of quantization is to rescale the coefficients and divide the result into bit planes. This is effectively a logarithmic interval quantization. If the histogram of the coefficients were exponentially distributed this would be an ideal method.

The effects of inadequate quantization particularly make themselves felt on restoring flat areas of the image with small intensity gradients: the reconstruction shows contouring which can be quite offensive. Fortunately, smart reconstruction, for example using diffusion of errors, can alleviate the appearance of the problem without damaging other parts of the image (see paragraphs [00183] and [00238]).

The wavelet plane's scaling factor must be kept as a part of the compressed data header.

Encoding. Once the wavelet transform has been thresholded and quantized, the number of distinct coefficient values is quite small (it depends on the number of quantized values) and Huffman-like codes can be assigned to them.

The code table must be preserved with each wavelet plane. It is generally possible to use the same table for large numbers of frames from the same video stream: a suitable header compression technique will handle this efficiently thereby reducing the overhead of storing several tables per frame. The unit of storage is the compressed wavelet groups (see below) and it is possible to have entire group uses the same table.

Bit Borrowing. Using a very small set of numbers to represent the data values has many drawbacks and can be seriously deleterious to reconstructed image quality. The situation can be helped considerably by any of a variety of known techniques. In one embodiment of this process, the errors from the quantisation of one data point are allowed to diffuse through to neighbouring data points, thereby conserving as much as possible the total information content of the local area. Uniform redistribution of remainders help suppress contouring in areas of uniform illumination. Furthermore, judicious redeployment of this remainder where there are features will help suppress damage to image detail and so produce considerably better looking results. This reduces contouring and other such artifacts. We refer to this as “bit-borrowing”.

Validation and encryption. We wish to know, when we see an image, that it is in fact the same image as was captured, compressed and stored. This is the process of image validation.

We might also want to restrict access to the image data and so encrypt the reconstruction coefficients, converting them to the correct values if the user supplies a valid decryption key.

Both these problems can be solved at the same time by encrypting the table of quantized wavelet coefficients. If the access is not restricted, a general key is used based on the stream data itself. If the data is authentic the data will decompress correctly. A second key is used if the data access is restricted.

Packaging. Compressed image data comes in “packets” consisting of a compressed reference frame or template followed by a set of frames that are derived from that reference. We refer to this as a Frame Group. This is analogous to a “Group of Pictures” in other compression schemes, except that here the reference frame may be an entirely artificial construct, hence we prefer to use a slightly different name. This is the smallest packet that can usefully be stored.

The group of wavelet transforms from those images comprising a frame group can likewise be called a wavelet group.

It is useful to bundle several such Frame Groups into a bigger package that we refer to, for want of a better term, as a “Data Chunk” and the packet of compressed data that derives from this as a “compressed data chunk”.

Frame groups may typically be on the order of a megabyte or less, while the convenient chunk size may be several tens of megabytes. Using bigger storage elements makes data access from disk drives more efficient, It is also advantageous when writing to removable media such as DVD+RW.

Synoptic Data

Compression and encryption. The synoptic data consists of a set of data images, each of which summarizes some specific aspect of the original image from which it was derived. Since the aspects that are summarized are usually only a small part of the information contained within the image, the synoptic data will compress to a size that is substantially smaller than the original image. For example, if part of the synoptic data indicates those areas of the image where foreground motion has been detected, the data at each pixel can be represented by a single bit (detected or not). There will in general be many zeros from areas where nothing is happening in the foreground

Synoptic data is losslessly compressed.

Packaging. The synoptic image data size is far smaller than the original data, even given that the original data has been cleaned and compressed.

For convenience of access the synoptic data is packaged in exactly the same way as the wavelet compressed data. All synoptic images relating to the images in a Frame Group are packaged into a Synoptic image group, and these groups are then bundled into chunks corresponding precisely to Chunks of wavelet-compressed data.

Database

Time Line. Since the original data comes in a stream it is appropriate to address data of all forms in terms of either or both a frame identifier and the time at which the frame was captured.

The compressed data is stored in Chunks that contain many frame groups. The database keeps a list of all the available chunks together with a list of the contents (the frame groups) of each chunk, and a list of the contents of each frame group.

The simplest database list for a stored data item consists of an identifier built up from an id-number and the start-end times of the stored data item, be it a chunk, a frame group or simply a frame. Keeping information about the size in bytes of the data element is also useful for efficient retrieval.

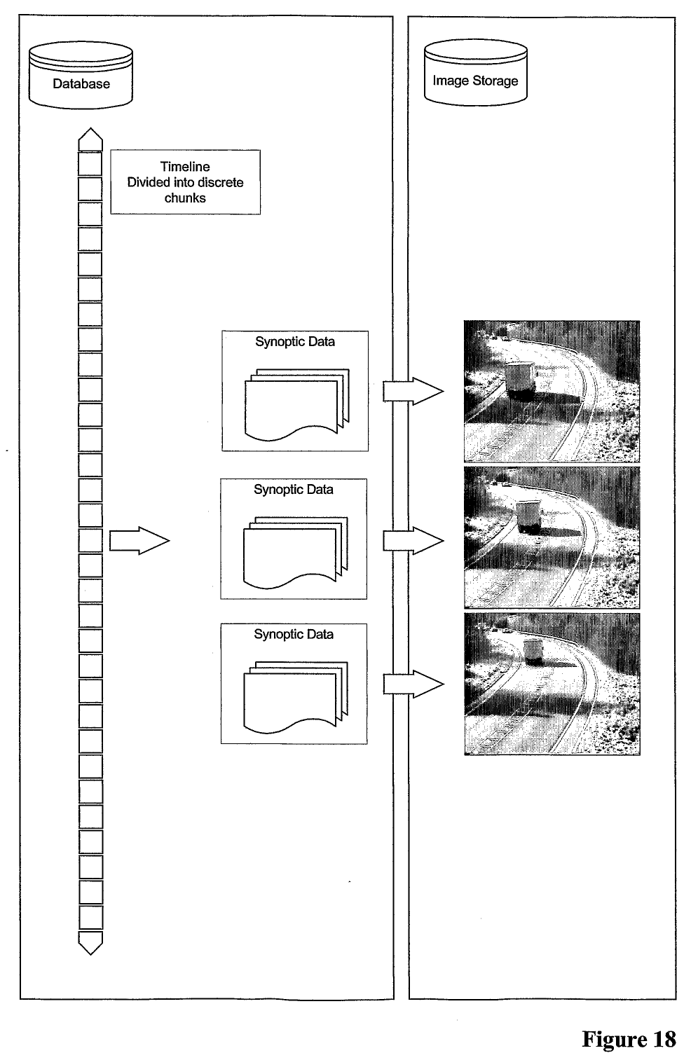

FIG. 18 shows how there is a one-to-one correspondence between Synoptic image data and wavelet-compressed data. The time line can be used to access either synoptic images for analysis, or wavelet compressed data for viewing.

Note that it is not necessary to keep the Synoptic data and the Wavelet compressed data in the same place.

Logical time division. Since a major application of this procedure is digital image recording with post-recording analysis capability, it makes sense to store the data on a calendar basis.

Synoptic images. Synoptic images are generally one-bit-plane images of varying resolution. It makes no sense to display them, but they are very efficient for searching.

Compressed image data. The compressed image data is the ultimate data that the user will view in response to a query.

This need not be stored on the same repository as the synoptic data, but it has to be referenced by the database and by synoptic data.

Data Storage

Databases. Ultimately the data has to be stored on some kind of storage media, be it a hard disk or a DVD or anything else.

At the simplest level, the data can be stored as a part of the computer's own filing system. In that case it is useful to store the data in logical calendar format. Each day a folder is created for that day, and data is stored on an hourly basis to an hour-based folder. (Using the UTC time standard avoids the vagaries associated with changes in clocks due to daylight saving).

At a higher level, the database itself may have its own storage system and address the stored data elements in terms of its own storage conventions.

The mechanism of storage is independent of the query system used: the database interface should provide access to data that has been requested, whatever the storage mechanism and wherever it has been stored.

Media. Computer storage media are quite diverse. The simplest classification here is into removable and non-removable media. Examples of non-removable media might be hard disks, though some hard disks are removable.

The practical difference is that removable media should keep their own databases: that makes them not only removable, but also mobile. Managing removable media in this way is not always simple; it depends on the database that is used and whether it has this facility. Removable media should also hold copies of the audit that describes how, when and where this data was taken.

Data Retrieval

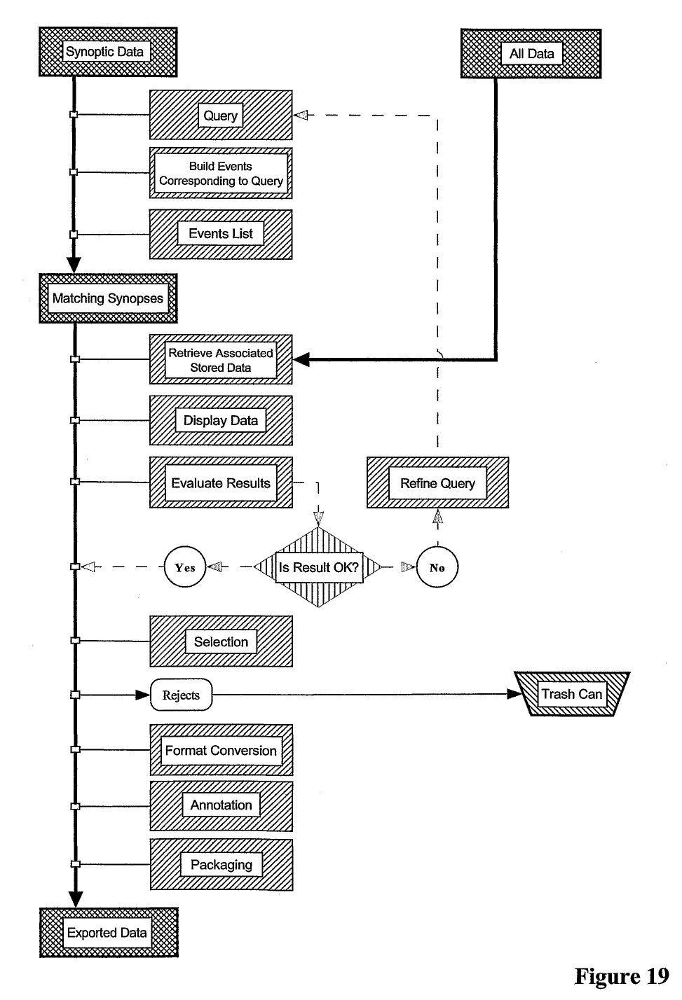

FIG. 19 shows the steps in the data retrieval and Analysis cycle. In response to a user query, the synoptic data is searched for matches to the query. With successful hits events are built and added to an event list that is returned to the user. The main image data is not been touched until the user wishes to view the events in the list. FIG. 18 depicts how the main stored data is associated with synoptic data.

On the basis of what is presented, the user can refine searches until an acceptable list of events is found. The selected list of events can be converted to a different storage format, annotated, packaged and exported for future use.

Queries

Search criteria. This kind of data storage system, in one particular embodiment, allows for at least two kinds of data search:

Search by time and date: The user requests the data captured at a given instant from a chosen video stream. If, in the Synoptic data, there was an event that took place close to the specified time that is flagged up to the user.

Search for event or object: The user specifies an area of the scene in a chosen video stream and a search time interval where a particular event may have happened. The Synoptic data for that time interval is searched and any events found are flagged to the user. Searching is very fast (several weeks of data can be search in under a minute) and so the user can efficiently search enormous time spans.

Recall that event finding within the Synoptic data is not predicated on any pre-recording selection criteria.

Multi-stream Search. Synoptic data lists from multiple streams can be built and combined according to logic set by the user. The mechanism for enabling that logic is up to the user interface; the search simply produces a list of all hits on all requested streams and then combines them according to the logical criteria set by the user.

The user may for example want to see what was happening on other video streams in response to a hit on one of his search streams. The user may wish to see only those streams that scored hits at the same time or within some given time interval. The user may wish to see hits in one stream that were contingent on hits being seen in other streams.

Events—the result of successful query. The result of a successful query should be the presentation of a movie clip that the user can examine and evaluate. The movie clip should show a sufficient number of frames of the video to allow the user to make that evaluation. If the query involved multiple video streams the display should involve synchronized video replay from those streams.

The technique used here is to build a list of successful hits on the Synoptic Data and package them with other frames into small movies or “Events”. The user sees only events, not individual frames unless they are asked for.

Synoptic Data Search

Hits. Searching the Synoptic Data amounts to searching a sequence of images for particular features. The advantage here is that the data is generally a single bit-plane and we only have to search a user nominated area for bits that are turned on. This is an extremely fast process that can be speeded up further if the Synoptic data map is suitably encoded.

Hits may come from multiple video streams, combining the results of multi-stream searches with logic set by the query.

Hits may modified according to the values of a variety of other attributes that are available either directly or indirectly from the Synoptic data such as total block score or direction of motion or size

Display. Having found the hits within the Synoptic Data sets, the hits from the Synoptic Data have to be built into an Event that can be displayed. There are then two options for display and evaluation. (1): Show the Trailers if they have been stored. (2): Go and get the full data.

Speed. The search of the Synoptic Data can be very fast because the analysis has already been done. Furthermore, the size of the synoptic data set is generally many orders of magnitude smaller than the original data. The slowest part of the search is in fact accessing the data from the storage medium.

This is especially true if the storage medium is DVD (access speed roughly 10 megabytes per second) in which case it is frequently useful to cache the entire synoptic database in memory. Intelligent multitasking of the user interface can easily do that: the first search will be the time to read the data while the following searches will be almost instantaneous.

Searches over a network are extremely efficient since the synoptic data is kept on a hard disk with fast local access and only the results have to be transmitted to the client.

Retrieving Associated Data

Defining and building events. An event is a collection of consecutive data frames from one or more data sources. At least one of the frames that make up this collection, the key frame, will satisfy some specified criterion that has been formulated as a user query addressed to the synoptic data. The query might concern attributes such as time, location, colour in some region, speed of movement, and so on. We refer to a successful outcome to the query as a “hit”.

Consider one embodiment of the process in which, if there is a single “hit”, the user will want to see a few seconds of video prior to the “hit” and a few seconds after that in order to appreciate the action. If two or more hits occur within a few seconds of each other they might as well be combined to give a longer event clip. Thus in this embodiment the successive hits are combined into the same clip if the interval between the hits is less than the sum of the pre and post hit times specified by the user.

It is possible to have a single key frame from one data stream represent an event covering multiple streams: that way all data streams associated with the key frame(s) can be cross-referenced. An event may comprise a plurality of data frames prior to and following the key frame that they themselves do not satisfy the key frame criterion (such as in pre-and-post alarm image sequences).

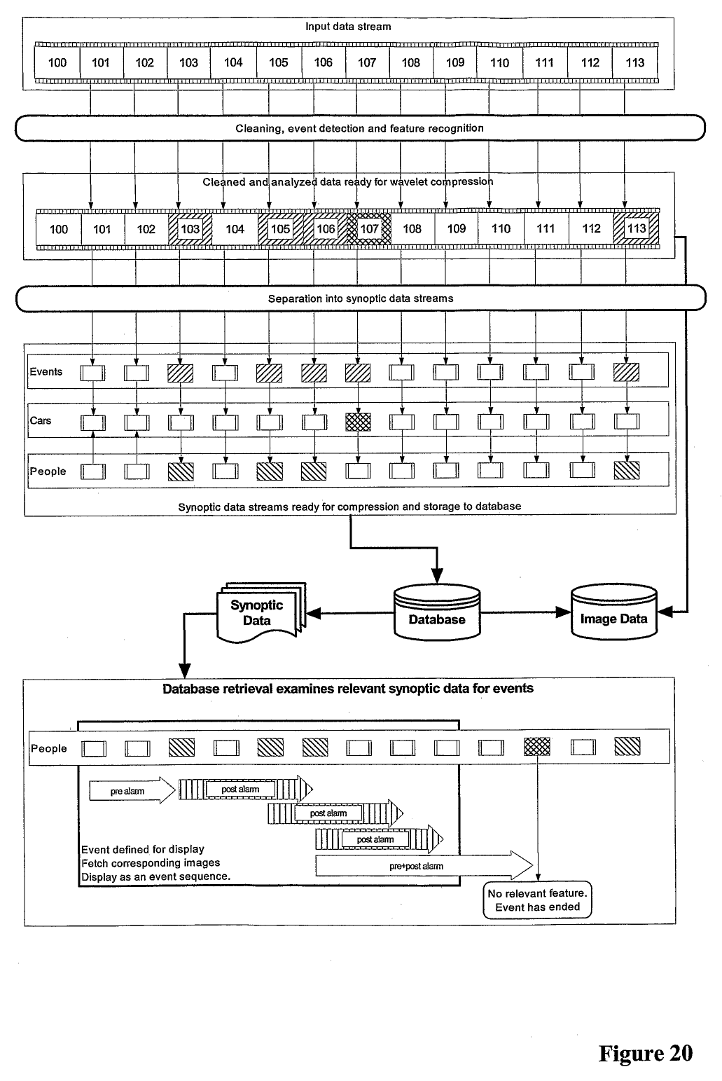

FIG. 20 depicts how data is acquired, processed, stored and retrieved. In response to a query key frames are found and events are built spanning those key frames.

Building the Event clip. Each frame of synoptic data is associated with the parent frame from which it was derived in the original video data (Wavelet compressed).

The frames referred to in an Event, as defined by the hits in the Synoptic data, are retrieved from the Wavelet Compressed data stream. They are validated, decrypted If necessary) and decompressed. After that they are converted to an internal data format that is suitable for viewing.

The data format might be a computer format (such as DIB or JPG) if they are to be viewed on the user's computer, or they may be converted back to an analog CCTV video format by an encoder chip or graphics card for viewing on a TV monitor.

Event analysis. Once the original video frames for the Synoptic data hit have been acquired, they can be analyzed to see if they satisfy other criteria which was not included in the synoptic data. Thus the synoptic data might not, because of limits on computing resources at the time of processing, have classified the objects into people, animals or vehicles. This classification can be done from combining whatever synoptic data is available for these streams and from the stored image.

Adding audio data. When an event is played back or exported it might be necessary to have access to any audio channels that might accompany the sequence.

The audio channel is, from the point of view of this discussion, merely another data stream and so is accessed and presented in exactly the same manner as any other stream.

Work Flow.

Data access and validation. If the data is encrypted then the user interface must request the authorization to decrypt the data before presenting it. All data recorded on the same computer will have the same user access code. Different streams may have supplementary stream access codes if they have different security levels.

The data validation is done at the same time as the decryption since the data validation code is an almost-unique result of a data check formula built on the image data. (We say “almost unique” since the code has a finite number of bits. It is therefore conceivable, though astronomically unlikely, that two images could have the same code).

Repeat or refined queries. The user interface has the option of repeating an enquiry or refining an enquiry, or even combining the result of one enquiry with the result of another on an entirely different data stream.

The search procedure within the synoptic data is so fast that it costs little to simply re-run an enquiry with different parameters or different logic. This is merely a matter of programmatic efficiency.

Data export—audits. Once the user has a set of events that satisfy the query, there is a need to store these discovered events in such a way that they can be used by other programs or used for display and information purposes.

An audit of how the results were achieved is published along with the export so that the procedure can be re-run if necessary. (The possibility of repeating the result of a search is sometimes required in legal cases).

Exported Data.

Event data can be exported to any of a number of standard formats. Most of these are formats that are compatible with Microsoft Windows™ software, some with Linux. Many are based around the MPEG standards (which is not supported by the current versions of Windows media Player!).

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

### Notation

Symbolic Notation

In what follows we shall, for clarity, use symbols to denote data and images of various kinds.

Data, Images and operators

Processes acting on these images, or combinations thereof, will be denoted as operators. Thus if F denotes an image frame and N denotes an operator that filters the noise, NF will denote the result of that process and F-NF will denote the residual to be identified as the noise component of F.

Operators acting sequentially are taken to act from right to left. Thus if N₁ and N₂ are two operators that can act on an image frame F, N₂N₁F is the result of first applying N₁ to F and then N₂.

Operators need not be linear and operators need not commute. In other words, if N₁ and N₂ are two operators that can act on an image frame F, N₁N₂F and N₂N₁F are not necessarily the same thing.

Generic time space-dependence of a frame F can be denoted by the symbol F(x,t), where x is the 2-dimensional image data of the frame at time t.

We shall also use pseudo-code to show how these various images are generated and inter-related. More details can be found in the Appendix.

Notation

| | Interpretation |
|---|---|
| Fₙ | n^{th.} raw frame in the sequence. |
| | The index n will run from negative values in |
| | the past to positive values in the future. |
| | n = 0 refers to the frame currently being |
| | processed. |
| F̅ₙ | n^{th.} processed frame in the sequence. |
| | The overbar may be replaced by any of a |
| | diversity of suitable decorations: dots, hats, |
| | tildes etc. to indicate the results of different |
| | processes. |
| Fₙ^{S}, Fₙ^{M}, Fₙ^{D} | Static, Moving and Dynamic components of |
| | frame after time resolution analysis. |
| Δₙ = Fₙ − Fₙ₋₁ | Difference between two successive raw frames |
| σ(D) | Variance of histogram of image data D. |
| Median(D) | Median of histogram of image D. |
| | The operator Median might equally be Smooth, |
| | Filter, Mask, Transform, or any descriptive |
| | word describing the operation. |
| | The operator name may be alternatively |
| | represented by a boldface symbol as in S, F, |
| | M, T. |
| Mₙ = M (Fₙ) | Masked version of n^{th}. frame |
| G(x, t) | General data dependent on position x and time, |
| | t. |
| G^{C} (x, t) | A specific component of G labeled with index |
| | C describing the nature of the component. |
| | Specific examples of component are noise |
| | (C = ‘N’), background data (C = ‘B’) and |
| | dynamic data (C = ‘D’). |

The notation can get quite heavy: consider the case where general data is described by a matrix of values whose size we wish to indicate specifically. We shall take the usual simplifying step of keeping only the necessary subscripts and superscripts, leaving out those that can be deduced from the context.
Equation numbering
Equations will bear two numbers: a direct reference to the section in which they are found and a reference to the number of the equation within that section. Thus an equation numbered ([0093]).3 is the third equation in section ([0093]).

### GLOSSARY

Bit Borrowing

The procedure whereby some parts of an image where a higher level of fidelity is needed can be compressed to a better quality than other parts of the image. In effect, one borrows bits from one part of the image to better represent other parts. This is achieved during the encoding of wavelet coefficients prior to storage. A special table of coefficient codes is produced for these areas of special interest. One can still use the shorter codes for the more populous values; the trick is to keep two tables. Along with the two tables it is also necessary to keep two values of the threshold and two values of the quantization scaling factor.
   CDF(2,2)
A simple member of a large class of bi-orthogonal wavelets from Cohen, Daubechies and Feaveau, also know as the bi-orthogonal 5-3 wavelet since it uses 5 points for its high-pass filter and 3 points for its low-pass filter.
   Current Image
The image in a sequence that is the current focus of interest. Although this will generally be the most recent image captured in the stream, it might be the last but one, the last but two or the last but n if the processing of the current image depends on a number of the subsequent images (as may happen if we are estimating time derivatives of images).
   DCD
Data Change Detection: the general form of VMD.
See also VMD, Video Motion Detecton
   Deviant Pixel
A pixel in an image which is deemed, on the basis of the time series analysis of its past history, to have a value that is exceptional in relation to what that history would indicate. Deviant pixels are defined in terms of the time behavior at each point, and their importance is evaluated in terms of their relative proximity to one another by scoring spatial patterns of deviant pixels.
   DivX
A video file format that popular due to its ability to compress lengthy video segments into small sizes while maintaining relatively high visual quality. DivX uses lossy MPEG-4 Part 2 compression: the DivX codec is fully MPEG-4-Advanced Simple Profile compliant. The DivX format is now subject to patent restrictions and is no longer Open Source. DivX is inferior to the new H.264/MPEG-4 AVC, also known as MPEG-4 Part 10, but is far less cpu intensive.
In the public domain it has been replaced by the Open Source format known as Xvid.
   Dynamic Foreground
Features in the scene that enter or leave the scene, or execute substantial movements, during the period of data acquisition comprise the dynamic foreground. (As opposed to the static and stationary background components).
See also Static Background, Stationary Background
   Event
An event is a collection of consecutive data frames from one or more data sources. At least one of the frames that make up this collection, the key frame, will satisfy some specified criterion (such as time, location, colour in some region, speed of movement, etc.). It is possible to have a single key frame from one data stream represent an event covering multiple streams: that way all data streams associated with the key frame(s) can be cross-referenced. An event may comprise a plurality of data frames prior to and following the key frame that themselves do not satisfy the key frame criterion (such as in pre-and-post alarm image sequences).
See also Video event Detection
   GUI
Graphical User Interface. This is a computer program, running on a computer, personal data assistant, mobile phone etc., which presents the user with a “windowed” or “graphical” view of available programs and data. The user controls programs and accesses data via a pointing device such as a mouse and a keyboard. The GUI defines the facilities and functionality with which a user can run programs and handle data.
   Image Mask
Regions in an image that are to be protected from certain operations on the image data. Thus a mask may be constructed to cover the edges of features in an image so that a smoothing operation does not create fuzzy features.
   Image Template
An image constructed from the current image and possibly a number of its predecessors. The purpose of such an image is to emphasize specific aspects of an image and its history. One example of a template might be the image consisting solely of the edges of the current image. Another might be an image that is some specific time average of the preceding images. By comparing the current image with a specially designed template we can isolate changes in specific aspects of the image.
   Mask
An image mask is a map of the region in an image, all points of which share some particular property. The map is itself an image, though a rather simplified one since it generally describes whether or not a point on the image has that particular property. A two-valued (Yes or No) map is a represented as single bit-plane. Masks are used to summarize specific information about one or more images such as where there is a dominant red colour, where there is motion in a particular direction and so on. The mask is therefore a map together with a list of attributes and their values that define the information content of the map.
Information from one or more masks goes towards building Synoptic Data for the data stream.
Masks may also used to protect particular parts of an image from processes that might destroy them if they were not masked.
See also Synoptic Data
   MPEG
The Motion Picture ExpertsGroup: an organization that has been in existence since 1988. They are responsible for the development of standards for coded representation of digital audio and video signals. The standards result in data file formats like MPEG-1, MPEG2, MPEG-4 and MP3. The documentation of the standards is not freely available, and the use of the standard is subject to licensing agreements. MPEG is not really an open source standard.
   Noise
The noise component is that part of the image data that does not accurately represent any part of the scene. It generally arises from instrumental effects and serves to detract from a clear appreciation of the image data. Generally one thinks of the noise component as being uncorrelated with or orthogonal to the image data (eg: superposed video “snow”), but this is not necessarily the case since the noise may depend directly on the local nature of the image.
   Pyramidal Decomposition
Successive scale reduction and decomposition of n-dimensional data into rescaled versions lower resolution versions of itself following the precepts of Mallat's Multiresolution decomposition. The errors in reconstructing a higher resolution dataset from its lower resolution predecessor are also stored. An example of this is the wavelet transform, but not all pyramidal decompositions are based on wavelets: the nonlinear pyramidal median transform being an important example.
   Random Camera Motion
Random, bounded, movement of the camera causes the perceived image sequence to shake, resulting in false movement detection. Random camera motion can be superposed on systemic camera motion, in which case it is seen as random deviations from otherwise smooth changes in image aspect.
See also Systemic camera motion
   Reference Image
An image, possibly artificial, against which it will be decided whether there have been any significant events taking place in the current scene. Artificial images can be constructed from other images that were taken in the past (an average would be an example of such). It is also possible (and indeed desirable if it can be done) to include images subsequent to the one that is currently being analyzed. See also Template.
   Scene Shift
A time in a video stream when the view of the static background component of the scene changes so much that the scenes immediately before and after the shift do not correlate spatially.
See also Scene marker
   Scene Marker
Notes where there is a significant change of scene. Such a change is usually due systemic movement of a camera starting a sequence with different view, or to a change in the camera providing the sequence. It might however mark a place where, for example, the lights get turned out.
See also Scene shift
   Sieve
The verb “to sieve” is synonymous with “to sift”. The dictionary definitions are “to examine in order to test suitability”, “to check and sort carefully”, and “to distinguish and separate out”. A Sieve (noun) is a device that allows one to sieve. In this document the noun is used in the sense of the mathematical concept exemplified by the Sieve of Eratosthenes, which is an algorithm to distinguish and separate out all prime numbers up to a given number, N. Thus we present a process whereby we can distinguish and separate out attributes in data streams.
See also Sift, Spatial Seive, Temporal Sieve
   Sift
As per the dictionary this means “to go through especially to sort out what is useful or valuable <sifted the evidence>—often used with through <sift through signals picked up by the Arecibo telescope>”. It also means “To make use of a sieve”, “To distinguish as if separating with a sieve” and “To make a careful examination”. See Sieve.
(The dictionary use is not to be confused with the acronym SIFT which has been adopted for “Scale-invariant feature transform”: a computer vision algorithm for extracting distinctive features from images, to be used in algorithms for tasks like matching different views of an object or scene (e.g. for stereo vision) and Object recognition).
See also Sieve
   Snapshot
A “Snapshot” is a single image taken from an event that provides a small thumbnail view of one frame of the action. Such frames can be part of a Trailer, or they can be specially constructed frames that are kept in the Synopsis.
   Spatial Sieve
An algorithm or device that extracts and preserves features that may be present in a spatially varying signal or series of signals. The Hough transform is a spatial sieve.
See also Sieve, Temporal Sieve
   Static Background
Consists of elements of the scene that are fixed and that change only by virtue of changes in camera response, illumination, or occlusion by moving objects. A static background may exist even while a camera is panning, tilting or zooming. Revisiting a scene at different times will show the same static background elements. Buildings and roads are examples of elements that make up the static background.
See also Stationary background, Dynamic Foreground
   Stationary Background
Consists of elements of the scene that are fixed in the sense that revisiting a scene at different times will show the same elements in slightly displaced forms. Moving branches and leaves on a tree are examples of stationary background components. The motion is localized and bounded and its time variation may be episodic. Reflections in a window would come into this category.
See also Static background, Dynamic Foreground
   Synoptic Data
The synoptic data consists of a set of data images, each of which summarizes some specific aspect of the original image from which it was derived.
   Systemic Camera Motion
Cameras may have the facility to pan, tilt and zoom under control of an operator or a programme. Under such circumstances we see a systemic shift in the scene that can be modeled through a series of affine transformations. If the movement is too rapid, consecutive scenes may bear little or no relation to each other.
See also Random Camera Motion
   Template
An image, possibly artificial, against which it will be decided whether there have been any significant events taking place in the current scene. Artificial images can be constructed from other images that were taken in the past (an average would be an example of such). It is also possible (and indeed desirable if it can be done) to include images subsequent to the one that is currently being analyzed. See also Reference Image.
   Temporal Sieve
An algorithm or device that extracts and preserves features that may be present in a time varying signal or series of signals. The pass-band of a filter is a frequency sieve selecting on the frequency content of the signal.
See also Sieve, Spatial Sieve
   Thumbnail
A small still picture showing the scene where activity was detected. These small images can be stored either as a parallel data stream or as part of the Synoptic Data. They can be displayed in place of the full image when a quick browsing of movie clips is required.
   Trailer
Small, under-sampled, versions of the frames that constitute an event. These small frames can be stored either as a parallel data stream or as part of the Synoptic Data. They can be replayed in place of the full data when a quick browsing of movie clips is required. A Trailer is not a collection of Thumbnails: that would be too costly to store.
   Video Event Detection
A video event is a collection of consecutive video frames from one or more video data sources. At least one of the frames that make up this collection, the key frame, is special in some way and defines the event. The collection of consecutive frames is a collection spanning all frames that contain key frames: there will be a criterion for how big a gap between key frames delineates different events. The collection may even include a number of frames preceding the first key frame and following the last key frame: this is the essence of pre-and-post event recording. This is in contrast with Video Motion Detection, which refers to the detection of motion in some region of a single video frame. The video frame where motion that was detected by Video Motion Detection is often a key frame defining a video event.
See also Event, VMD, Video Motion detection
   Video Frame
A frame as used herein is defined as the smallest temporal unit of a video sequence to be represented as a single image.
   Video Sequence
A video sequence as used herein is defined as a temporally ordered sequence of individual digital images which may be generated directly from a digital source, such as a digital electronic camera or graphic arts application on a computer, or may be produced by the digital conversion (digitization) of the visual portion of analog signals, such as those produced by television broadcast or recorded medium, or may be produced by the digital conversion (digitization) of motion picture film.
   Video Motion Detection
Video Motion Detection: one of the primary goals is to find changes in the scene which are not simply due to variations in the ambient conditions. Motions are of several types. We distinguish general changes (such as trees moving in the wind) from changes due to intrusions (such as vehicles). The former motion is recognized by the fact that such motion is bounded within the scene and is manifestly recurrent.
   VMD
See Video Motion Detection
   Wavelet Coefficients
The representation of an image by means of the wavelet transform produces an array of numbers that can be used to precisely reconstruct the image. The transformation is effected by processing groups of image pixels with a set of numbers referred to as wavelet coefficients. There are many types of wavelet, each represented by its own particular set of coefficients. From the point of view of image compression, those coefficient sets that allow the maximal compression are advantageous. However, the data produced by those coefficients will censored and approximated in order to gain a greater level of compression. Hence sets of coefficients that give a robust and accurate reconstruction in the face of this censorship and approximation are also to be preferred. Many debates center around which particular sets of wavelet coefficients do the best job in both these respects.
   Wavelet Compression
Two factors make it possible to achieve significant compression of wavelet data. The hierarchical structure of the wavelet representation of the image predisposes towards there being large number of almost zero valued coefficients that are hierarchically related. The process of coefficient thresholding enhances the number of zero values in this hierarchy and the quantization process ensures that non-zero values are efficiently represented. It is therefore possible to represent the data in a far more efficient way consuming far less storage space.
   Wavelet Encryption

When wavelet coefficients have been quantized, there are relatively few values represented by codes that are stored in a lookup table (see Wavelet quantization). The code number can be looked up for reconstruction. However, before storage it is possible to encrypt the table that provides the code values, as a result of which programs without access to the crypt method will not be able to reconstruct the image.

Wavelet Kernel

The wavelet transform of an image consists of a hierarchy of images of ever-decreasing size. The scale factor between levels of the hierarchy is generally, but not necessarily, a linear factor of 2: a 2×2 block of four pixels become one pixel. We refer to the smallest level that is used as the “Wavelet kernel” since all higher (larger) images are built from this via the inverse wavelet transform.
   Wavelet Quantization
The wavelet transform of data consists of a set of numbers that can be used to reconstruct the original data. In order to achieve substantial levels of compression it is useful to simplify those numbers, representing the actual values by a few representative values. The way in which the representative values are selected has to be such that the result will not make a perceptible change to the reconstructed data. This process is referred to a quantization since it changes what is essentially a continuous set of values (the original wavelet coefficients) into a suitable set of discrete values. The fewer discrete values can be coded, replacing each value with a specific code that can be looked up during the reconstruction process. Thus the value 29.6135 can be represented by the letter ‘W’ and every ‘W’ replaced by 29.6135 on reconstruction. The coding opens the possibility of encrypting the data.
   Wavelet Thresholding
The wavelet transform of data consists of a set of numbers that can be used to reconstruct the original data. In order to achieve substantial levels of compression it is useful to throw away those numbers that are small enough that their loss will not make a perceptible change to the reconstructed data. Thresholding is one way in which a decision is made as to whether a number can be safely discarded. There are many ways of deciding what the optimal values of the threshold might be and what to do with the data once the thresholding has been done. One such method is referred to as “SURE” (“Stein's Unbiased Risk Estimator”).
   Wavelet Transform
A transformation of sequential or image data in which the transformed data has half the linear scale length of the original data. The reduced dataset is kept with another dataset that contains the information necessary to reconstruct the original data from the reduced version. The possibility of reconstructing the original data from the shrunken data is a key feature of wavelets.
   XviD
XviD is a free and open source MPEG-4 video codec. XviD was created by a group of volunteer programmers after the OpenDivX source was closed in July 2001. In the 1.0.x releases, a GNU GPL v2 license is used with no explicit geographical restriction; however, the legal usage of XviD may still be restricted by local laws. Note that XviD encoded files can be written to a CD or DVD and played in a DivX compatible DVD player.

1. A method for interrogating or searching a body of sequential digitised digitized data using the following steps:
(a) decompose data using pyramidal decomposition;
(b) apply a sifting process to separate information about data attributes (synoptic data);
(c) store the data and the synoptic data with an index;
(d) set up the interrogation or search criteria;
(e) retrieve synoptic data;
(f) apply the interrogation or search criteria to the retrieved synoptic data.

2. A method as claimed in claim 1 wherein the index is used to retrieve the corresponding main data.

3. A method as claimed in claim 1 wherein the decomposition is made using wavelets.

4. A method as claimed in claim 2 wherein the decomposition is made using an adaptive wavelet hierarchy.

5. A method as claimed in claim 1 wherein the sifting process is used to extract noise attributes.

6. A method as claimed in claim 1 wherein the sifting process is used to extract information about a static background.

7. A method as claimed in claim 1 wherein the sifting process is used to extract information about a stationary background.

8. A method as claimed in claim 1 wherein the sifting process is used to extract information about dynamic movements.

9. A method as claimed in claim 1 wherein the sifting process is used to extract information about objects.

10. A method as claimed in claim 4 wherein synoptic data takes the form of one or more masks.

11. A method for aiding the computation of wavelets for applications using pyramidal decomposition by
(a) parameterizing families of even-point wavelets using a continuous variable;
(b) using the variable to generate sets of wavelet coefficients.

12. A method as claimed in claim 11 wherein sets of coefficients are generated which can be expressed exactly with an 8-bit representation.

13. A method as claimed in claim 11 wherein the wavelet coefficients are “tuned” to a given scale.

14. A method for processing a sequence of digitized data using pyramidal decomposition by wavelets, wherein each data set in the sequence is transformed into a wavelet representation using an appropriate wavelet.

15. A method as claimed in claim 14 wherein the adaptive compression uses an iterative loop consisting of several processing nodes in order to perform the first phase of video sequence resolution by splitting the data into different components, comprising: noise; cleaned data; and static, stationary and dynamic data.

16. A method as claimed in claim 14 wherein on the first iteration a data-point by data-point difference between the wavelet transforms of an image in the sequence and the wavelet transforms of a reference image is computed.

17. A method as claimed in claim 14 wherein on a later iteration the process of Wavelet Kernel Substitution is used to eliminate the frame differences due to changes in illumination.

18. A method as claimed in claim 17 wherein the Wavelet Kernel Substitution replaces the low resolution features of the current image with those same features of a previous image in order to adjust for changes in illumination.

19. A method as claimed in claim 18 wherein the kernel component of the current template is put in place of the kernel component of the current image to produce a new version of the current image and its wavelet transform.

20. A method as claimed in claim 19 wherein the new data J can be used in place of the original image I in order to estimate noise and compute the various masks.

21. A method as claimed in claim 14 wherein the principle features of the first level wavelet transform of the frame difference are correlated and used to calculate the systemic camera movement. The computed shift is then logged for predicting subsequent camera movement via an extrapolation process.

22. A method as claimed in claim 21 wherein a digital mask is computed recording those parts of the current image that overlap its predecessor and the transformation between the overlap regions calculated and stored.

23. A method as claimed in claim 22 wherein any residuals from systemic camera movement are treated as camera shake and the static components of the image are used to build up a background template to adjust for the camera shake.

24. A method as claimed in claim 14 wherein the mask is created by refining the statistical parameters of the distribution of the image noise, and using those parameters to separate the image into a noise component and clean component.

25. A method as claimed in claim 24 wherein those parts of the image that differ by less than the determined threshold are used to create a mask that defines those regions where the image has not changed relative to its predecessor. The mask is adjusted on each iteration as more information is gained about the scene.

26. A method as claimed in claim 14 wherein the current cleaned image is subjected to a pyramidal decomposition sing a novel adaptive wavelet transform which uses a different wavelet whose characteristics are adapted to the image characteristics at each level of the pyramid.

27. A method as claimed in claim 14 wherein the kernel-modified current image is compared to the previous template and the differences logged as motion within the scene.

28. A method as claimed in claim 27 wherein a mask is created of the motion within the scene and stored for later reference.

29. A method as claimed in claim 14 wherein a template is created using the formula Tj=(1-α) Tⱼ₋₁+αIⱼ to smooth the stationary background and eliminate or reduce the presence of moving foreground.

30. A method as claimed in claim 14 wherein a plurality of templates are stored for a plurality of α values where α is the memory parameter as defined in claim 14.

31. A method as claimed in claim 14 wherein the current image and its pyramidal representation are stored as templates for possible comparisons with future data.

32. A method as claimed in claim 14 wherein the decision thresholds are set dynamically in order to desensitize areas where there is background movement.

33. A method as claimed in claim 32 wherein the loss of background sensitivity through the use of dynamic decision thresholds is compensated for by using templates that are integrated over a period of time in order to blur the localized movements.

34. A method as claimed in claim 14 wherein the image places where movement was detected are reassessed in the light of spatial correlations between detections and temporal correlations describing the history of that region of the image.

35. A method as claimed in claim 14 wherein the dynamic foreground data is analyzed both spatially and temporally.

36. A method as claimed in claim 35 wherein the spatial analysis is a correlation analysis where each element of the dynamic foreground is scored according to the proximity of its neighbors among that set.

37. A method as claimed in claim 35 wherein the temporal analysis is done by comparing the elements of the dynamic foreground with the corresponding elements in previous frames and with the synoptic data that has already been generated for previous frames.

38. A method as claimed in claim 35 wherein the spatial and temporal correlation scoring are interpreted according to a preassigned table of spatial and temporal patterns.

39. A method as claimed in claim 14 wherein image masks are generated for each of the attributes of the data stream, delineating where in the image data the attribute is located.

40. A method as claimed in claim 14 wherein the adaptively coded wavelet data is compressed first by a process of locally feature dependent adaptive threshold and quantization to reduce the bit rate, and then an encoding of the resulting coefficients for efficient storage.

41. A method as claimed in claim 40 wherein those places in the wavelet representation where there is stationary but not static background are coded with a mask and given their own threshold and quantization.

42. A method as claimed in claim 14 wherein the image data G is represented as the sum of a number of time dependent components having distinct time constraints.

43. A method as claimed in claim 14 wherein a noise filter is mated and applied through the use of a masking technique.

44. A method as claimed in claim 14 wherein the wavelet used at different levels is changed from one level to the next by choosing different values of this parameter.

45. A method as claimed in claim 14 wherein templates are used as reference images against which to evaluate the content of the current image or some variant on the current image.

46. A method as claimed in claim 14 wherein estimators of the first and second time derivatives of the image stream at the time Iⱼ are used.

47. A method as claimed in claim 14 wherein for a known probability density for the noise distribution the levels can be adjusted so that there is a known probability that a pixel will falsely be deemed to be deviant and the moving background can be compensated for.

48. A method as claimed in claim 47 wherein when tracking the deviant pixels, the criteria developed use the time series history of the variations at each pixel without regard to the location of the pixel or what its spatial neighbors are doing.

49. A method as claimed in claim 48 wherein if the probability density for the noise distribution is not known the decision can be made non-parametrically.

50. A method as claimed in claim 14 wherein the parameters are set with default values and can be auto-adjusted after looking at a short sequence of frames.

51. A method as claimed in claim 14 wherein block scoring is used to assess the degree of clustering of the deviant pixels by assigning a score to each deviant pixel depending on how many of its neighbors are themselves deviant.

52. A method as claimed in claim 14 wherein a wavelet kernel substitution based method of using motion vectors to identify and track objects in the scene is used.

53. A method as claimed in claim 14 wherein the velocity field is calculated using spatial gradients on all scales of the adjusted logarithm of the SS component of the wavelet transform.

54. A method as claimed in claim 14 wherein the adaptive compression consists of determining a threshold below which coefficients will be set to zero in some suitable manner, quantizing the remaining coefficients and efficiently representing or coding those coefficients.

55. A method as claimed in claim 14 wherein the adaptive compression uses the methods of adaptive thresholding and adaptive quantization to perform the task of image compression, whilst maintaining the image quality of the areas of special interest in the frame.

56. A method as claimed in claim 14 wherein the process of “bit borrowing” is used, allowing the errors from the quantization of one data point to diffuse through to neighboring data points, in a feature dependent manner thereby conserving as much as possible the total information content of the local area.

57. A method as claimed in claim 14 wherein all synoptic images relating to the images in a Frame Group are packaged into a Synoptic image group, and these groups are then bundled into chunks corresponding precisely to chunks of wavelet-compressed data.

58. A method as claimed in claim 14 wherein the compressed image data is stored and referenced by the database and the synoptic data.

59. A method as claimed in claim 14 wherein when searching by time and date, the user request the data captured at a given instant from a chosen video stream and the event derived from the synoptic data that took place close to the specified time is returned to the user.

60. A method as claimed in claim 14 wherein when searching for an event or object, the user specifies the area of the scene in a chosen video stream and a search time interval where a particular event may have happened and the synoptic data for that area and time interval is searched and the corresponding events are built and returned to the user.

61. A method as claimed in claim 14 wherein searching the synoptic data, the data is a single bit-plane meaning that only a user nominated area has to be searched for bits that are turned on.

62. A method as claimed in claim 14 wherein when successful queries are made of the synoptic data, the corresponding events are built and added to an events list that is returned to the user.

63. A method as claimed in claim 62 wherein an event may comprise a plurality of data frames prior to and following the key frame even though they themselves may not satisfy the key frame criterion.

64. A method as claimed in claim 14 wherein once the synoptic data hit has been acquired, if for some reason the objects have not been classified into subsets, the classification can be done from combining whatever synoptic data is available for these streams and from the stored image
